(19) United States
(12) Patent Application Publication
(10) Pub. No.: US 2013/0284667 A1
(43) Pub. Date: Oct. 31, 2013

(54) Polymer Filtration Membranes Containing Mesoporous Additives and Methods of Making the Same

(71) Applicants: Thomas J. Pinnavaia, East Lansing, MI (US); Volodymyr V. Tarabara, East Lansing, MI (US)

(72) Inventors: Thomas J. Pinnavaia, East Lansing, MI (US); Volodymyr V. Tarabara, East Lansing, MI (US)

(21) Appl. No.: 13/737,285

(22) Filed: Jan. 9, 2013

Related U.S. Application Data
(60) Provisional application No. 61/584,793, filed on Jan. 9, 2012.

(51) Int. Cl. B01D 71/04

(52) U.S. Cl. CPC B01D 71/04
USPC 210/500.25; 210/500.21; 210/500.26; 210/500.27; 264/212; 264/442

(57) ABSTRACT

Polymer composite membranes containing mesoporous particles which function in part as reinforcing agents, modifiers of polymer surface polarity, and membrane structure modifiers are provided. The composites provide superior resistance to internal damage and pore compaction, increased permeability to water with retention of separation fidelity, and resistance to chemical degradation and mechanical wear, along with minimal shedding of the reinforcing particles under applied pressure. These improvements in properties are particularly desirable for the water purification by membrane filtration methods.

The present invention claims priority under 35 U.S.C. §119 to U.S. Provisional Patent Application No. 61/584,793, entitled “Polymer Filtration Membranes Containing Mesoporous Additives”, filed Jan. 9, 2012, which is incorporated herein by reference in its entirety.

### STATEMENT REGARDING FEDERALLY SPONSORED RESEARCH

This invention was made with U.S. Government support awarded by the National Science Foundation Grant No. 1214993 “SBIR Phase I: Polymer Mesocomposites: Novel Materials for Compaction-Resistant, High-Flux Water Treatment Membranes.” The United States has certain rights in this invention.

### FIELD OF THE INVENTION

The present invention relates to the use of mesoporous additives for the improved performance of polymer membranes. More particularly, the present invention relates to multifunctional enhancements of composite, water purification membrane properties.

### BACKGROUND OF THE INVENTION

The entire world is facing, or soon will be facing, acute water shortages. Exacerbating this problem is the rapid industrialization of developing nations and an ever increasing demand for agricultural products. The problems caused by a lack of clean water are legion. According to a 2007 World Health Organization (WHO) report, 1.1 billion people lack access to an improved drinking water supply, 88% of the 4 billion annual cases of diarrheal disease are attributed to unsafe water and inadequate sanitation and hygiene, and 1.8 million people die from diarrheal diseases each year. The WHO estimates that 94% of these diarrheal cases are preventable through modifications to the environment, including access to safe water. Lack of clean water is also responsible for the chronic retardation of children's physical and mental development.

A number of techniques are used for transforming non-potable water into potable water. Of these, membrane filtration is widely used in industrial applications due to its ability to efficiently remove virtually all particles larger than 0.2 μm, including bacteria such as Giardia lamblia and Cryptosporidium parvum. Membranes are also a critical component in reverse osmosis desalination plants. As such, the use of membrane technologies has greatly increased over the course of the last two decades. As an example, the global installed capacity for low-pressure membrane systems, including drinking water, wastewater, and industrial water treatment plants, has grown from approximately 100 MGD in 1996 to almost 3,500 MGD in 2006. Nevertheless, there remains a need for new materials-based strategies for achieving extended longevity and high flux separations without sacrificing selectivity.

High permeability with retention of filtration selectivity is essential for commercial applications of polymer membranes. Although membrane-based water treatment is an established industry, existing membrane technology is far from providing optimal sustainability, particularly due to performance decline caused by compaction, fouling, repeated cleaning to alleviate fouling, and resulting gradual deterioration of the membrane material. In an ideal world, one would like a membrane that lasts as long as the physical plant itself. The reality, however, is an average life time that is comparatively short (5 to 7 years is a typical lifetime for most commonly used membranes) and dependent on membrane susceptibility to fouling and durability toward multiple cleanings.

A review article published recently by researchers at Asahi Kasei Corporation points out that although a variety of polymers are used for the purification of water through microfiltration and ultrafiltration, they are roughly classified into two groups, namely, Group 1 polymers characterized by hydrophilicity (e.g., cellulose based, polyacrylonitrile, functionalized polyethylene) and Group 2 polymers characterized by high strength and high durability (e.g., polysulfone (PSf), polyvinylidene fluoride (PVDF)). Group 1 polymers are aimed at a stable and high level filtration rate by inhibiting membrane biofouling and fouling due to organic substances in raw water. On the other hand, the Group 2 polymers are aimed at a stable and high level filtration rate over a long period by preventing mechanical breakdown and intensifying chemical cleaning by using materials enhanced in mechanical strength and chemical resistance. Importantly, these experienced researchers state “At present, there is no material that satisfys (sic) both requirements at the same time.” [N. Kubota, T. Hashimoto, and Y. Mori “Chapter 5: Micro filtration and Ultrafiltation” Advanced Membrane Technology and Applications. Eds. N. N. Li, A. G. Fane, W. S. W. Ho, and T. Matsuura, 2008, John Wiley & Sons, Inc., pp 105]

High transmembrane pressure differentials lead to irreversible changes in the macrovoid structure of a polymer membrane, resulting in decreased pore volumes and non-recoverable losses in hydraulic permeability. The detrimental effects of physical compaction can be viewed as internal irreversible fouling and are an intrinsic negative feature of membrane separation technology. In particular, ultrafiltration (abbreviated, UF), which is a staple membrane technology used to treat low turbidity surface waters and to pre-treat feed water for reverse osmosis desalination, suffers from pressure-induced compaction. Relatively large pressure differentials employed to drive the UF process are required because UF membranes have smaller pores so that smaller particles such as viruses and high molecular weight dissolved species (e.g., humic and fulvic acids) can be removed. Nanofiltration membranes used for water softening have even smaller pores, require higher transmembrane pressures, and also suffer the disadvantage of pore compaction. There is also growing evidence that compaction of the support layer (typically—an UF membrane) of thin film composite reverse osmosis membranes leads to deleterious changes in the structural and salt-rejecting performance of the separation layer and decreased desalination performance [Pendergast, M.T.M., J.M. Nygaard, A.K. Ghosh, and E.M.V. Hoek, Using nanocomposite materials technology to understand and control reverse osmosis membrane compaction. Desalination, 2010. 261 (3): p. 255-263]. In addition, membrane bioreactor technology, which is increasingly looking at smaller pore size membranes capable of virus removal, can experience the negative effects of membrane compaction [Judd, S., The MBR Book. Principles and Applications of Membrane Bioreactors for Water and Wastewater Treatment. 2nd ed. 2011: Butterworth-Heinemann]

Recent research has shown that the addition of nanoparticles to polymer ultrafiltration membranes reinforce the membrane and reduce pore compaction. Although nanoparticle-induced changes in the membrane structure are specific to the particular filler/matrix combination, certain common trends could be identified. Increasing nanoparticle loadings led to: (1) increased skin layer thicknesses (2) higher surface porosity of the skin, (3) suppressed macrovoid formation and (4) higher permeability of the membrane. Rejection fidelity was reported to either peak at intermediate loadings [Yang, Y., H. Zhang, P. Wang, Q. Zheng, and J. Li, The influence of nano-sized TiO2 fillers on the morphologies and properties of PSF UF membrane. J. Memb. Sci., 2007. 288 (1-2): p. 231-238], decrease after a threshold in filler loading was exceeded, or remain unchanged [Yan, L., Y.S. Li, C.B. Xiang, and S. Xianda, Effect of nano-sized Al2O3-particle addition on PVDF ultrafiltration membrane performance. J. Membr. Sci., 2006. 276 (1-2): p. 162-167].

Genne et al. [Effect of the addition of ZrO₂ to polysulfone based membranes”, J. Memb. Sci, 1996, 113 343-350] reported increasing permeability of polysulfone membranes with increasing amounts of zirconia particles in the membrane. The observed increase in permeability with increasing particle loading was attributed to the effect of the particle grains on the membrane pore structure formed during the phase-inversion process. Scanning electron micrographs revealed the presence of inter-particle pores in the agglomerated zirconia particles. Because the size of the particle pores (20-30 nm) were of equal magnitude as the membrane surface pores, it was recognized that the particles themselves could contribute directly to membrane permeability if the grains were actually situated in the skin layer of the membrane. However, field emission scanning electron microscopy images of the zirconia grains revealed that many of the “pores” are surface irregularities (indentations). Also, because the pores in the grains have high tortuosity and, therefore, a high resistance to fluid flow, these workers expected the contribution of the pores of the ZrO₂ grains to membrane permeability to be “insignificant”. A more recent report studied the effects of sintered zirconia particles with surface areas of 4-22 m²/g and pore volumes of 0.006-0.10 cm³/g on the permeability and selectivity of polysulfone composite membranes.

Recently published articles disclosed the incorporation of sulfonated mesoporous silica particles in a sulfonated polyethersulfone electrodialysis membrane for the purpose of increasing the cation exchange capacity and ionic conductivity of the membrane for water desalinization applications [C. Klaysom et al., “Synthesis of composite ion-exchange membranes and their electrochemical properties for desalination applications”, J. Mater. Chem., 2010, 203, 4669-4674. Klaysom et al., “Preparation of porous composite ion-exchange membrane for desalination application” J. Mater. Chem. 2011, 21, 7401-7409]. The composite membrane made by solvent evaporation showed serious aggregation of the silica particles at the membrane surface. Membranes made by phase inversion methods, resulted in the dispersion of the particles in the membrane pores. There was no evidence for the incorporation of particles within the polymer matrix. The observed increase in membrane permeability was attributed to the enlargement of membrane pores due to electrostatic repulsions between the negatively charged sulfonate groups on the particles and like groups in the polymer matrix. The size of the filler-occupied membrane pores increased with increasing loading due to clustering of particles within the membrane pores.

Although polymer filtration membranes represent an established technology for the purification of water, there nevertheless remains a need for improving the performance properties of such membranes. The effectiveness of contemporary filtration membranes is limited by the pressure-dependent compaction of the membrane pores (which reduces permeability) and an inverse relationship between permeability and separation fidelity. Normally, permeability is improved at the expense of cut-off selectivity. The resistance toward fouling and durability toward cleaning and mechanical damage are additional properties requiring improvement.

Thus, a need exists for filtration membranes having superior resistance to internal damage and pore compaction. Moreover, a need exists for filtration membranes having an increased permeability to water while also retaining separation fidelity. Further, a need exists for filtration membranes having increased resistance to chemical degradation and mechanical wear.

Specifically, a need exists for filtration membranes comprising polymer and particles that function as reinforcing agents, modifiers of polymer surface polarity, and/or membrane structure modifiers. A need further exists for filtration membranes comprising polymer and particles having decreased or relatively minimal shedding of the particles, especially under applied pressure.

Still further, a need exists for improved filtration membranes that may be used for water purification and/or for other purposes.

### SUMMARY OF THE INVENTION

The present invention relates to the use of mesoporous additives for the improved performance of polymer membranes. More particularly, the present invention relates to multifunctional enhancements of composite water purification membrane properties.

To this end, in an embodiment of the present invention, polymer composite membranes are provided. The polymer composite membranes comprise polymer and an amount of mesoporous particles selected from the group consisting of mesoporous silicate particles (MSP), mesoporous metal oxides particles (MOP), mesoporous carbon particles (MCP), mesoporous metal particles (MMP), mesoporous non-oxidic ceramic particles (MNO), mesoporous metal calcogenides (MMC), mesoporous polymer particles (MPP), mesoporous organosilica (MOS) particles, periodic mesoporous organosilica (PMO) particles, mesoporous metal phosphate (MMF), and combinations thereof.

More specifically, in an embodiment of the present invention, a polymer membrane composite composition is provided. The polymer membrane composite composition comprises mesoporous particle additives selected from the group comprising a mesoporous silicate, a mesoporous metal oxide, a mesoporous carbon, a mesoporous metal particle, a mesoporous non-oxidic ceramic particle, a mesoporous metal calcogenide particle, a mesoporous polymer particle, a mesoporous organosilica particle, a periodic mesoporous organosilica particle, a mesoporous metal phosphate, and combinations thereof, wherein the loading of the mesoporous additive is between 0.10% and 50% on a weight basis.

Further, in an embodiment of the present invention, a polymer membrane composite composition is provided wherein the mesoporous particle additive is effective in increasing the water permeability, decreasing the molecular weight cutoff, or decreasing the compaction of the composite membrane in comparison to the membrane without the additive.

In a further aspect of the present invention, a polymer composition is provided. The polymer composition comprises a polymer and an additive which are formed into a permeable membrane, the additive comprising mesoporous silicate particles, wherein the polymer composition has greater permeability with retention of molecular weight cutoff as a comparable membrane without the additive.

The said mesoporous particles can function in part as reinforcing agents, modifiers of polymer surface polarity, and membrane structure modifiers. The composites provide 1) superior resistance to internal damage and pore compaction, 2) increased permeability to water with retention of separation fidelity, and 3) resistance to chemical degradation and mechanical wear, along with minimal shedding of the reinforcing particles under applied pressure.

In a further embodiment of the present invention, a composite membrane composition is provided. The composite membrane composition comprises mesoporous particles at a loading effective to increase the pure water flux in comparison to a neat membrane composition comprising a membrane composition without the mesoporous particles, wherein the composite membrane composition and the neat membrane composition are prepared under analogous conditions.

In an embodiment, the mesoporous particles are mesoporous metal oxide particles.

In an embodiment, the mesoporous metal oxide particles are made from a metal component selected from the group consisting of silicon, aluminum, transition metals, post-transition metals, metalloid elements, lanthanide elements, actinide elements, alkali metal, and alkaline earth elements, and combinations thereof.

In an embodiment, the mesoporous particles are selected from the group consisting of mesoporous silicate particles, mesoporous metal oxide particles, mesoporous carbon particles, mesoporous metal particles, mesoporous non-oxidic ceramic particles, mesoporous metal calcogenide particles, mesoporous polymer particles, mesoporous organosilica particles, periodic mesoporous organosilica particles, mesoporous metal phosphate particles, and combinations thereof.

In an embodiment, the mesoporous particles are selected from the group consisting of silica, alumina, zirconia, aluminosilicate, titania, niobia, molybdenum oxide and combinations thereof.

In an embodiment, the mesoporous aluminosilicate is selected from the group comprising a clay and a zeolite.

In an embodiment, alumina is selected from the group consisting of amorphous alumina, gamma-alumina, eta-alumina, gibbsite, boehmite, and mixtures thereof.

In an embodiment, titania is selected from the group consisting of amorphous titanium dioxide, rutile, anatase, and mixtures thereof.

In an embodiment, the mesoporous particles are non-oxide mesoporous particles.

In an embodiment, the mesoporous particles are prepared in the presence of surfactant micelles as porogens.

In an embodiment, each of the mesoporous particles has a surface, wherein the surfaces of the mesoporous particles are modified by a coating of carbon.

In an embodiment, each of the mesoporous metal oxide particles has a surface, wherein the surfaces of the mesoporous metal oxide particles are modified by a coating of carbon.

In an embodiment, each of the mesoporous particles has a surface, wherein the surfaces of the mesoporous particles are modified by an organofunctional group.

In an embodiment, each of the mesoporous metal oxide particles has a surface, wherein the surfaces of the mesoporous metal oxide particles is modified by an organofunctional group.

In an embodiment, the composite membrane is made by a process selected from the group consisting of a liquid phase inversion processes, a phase inversion during compounding process, and an interfacial polycondensation reaction process

In an embodiment, the composite membrane composition is made by dispersing mesoporous particles in a solvent phase of a phase inversion casting solution using high shear mixing.

In an embodiment, the composite membrane composition is made by dispersing mesoporous particles in a phase inversion solvent of a casting solution using high intensity ultrasound sonication.

In an embodiment, the composite membrane composition is made by dispersing the mesoporous particles in a thermoplastic polymer matrix under melt compounding conditions prior to dissolving the thermoplastic polymer matrix in a phase inversion casting solvent.

In an alternate embodiment of the present invention, a phase inversion method of making a composite membrane is provided. The method comprises the steps of providing an amount of mesoporous particles; dispersing the mesoporous particles in a solvent phase of a casting solution using high shear mixing; forming a composite membrane composition with the casting solution having mesoporous particles dispersed therein, wherein the amount of mesoporous particles in the composite membrane is sufficient to increase the pure water flux of the composite membrane in comparison to a neat membrane without the mesoporous particles, wherein the composite membrane and the neat membrane are prepared under analogous phase inversion processes.

In an embodiment, the mesoporous particles are mesoporous oxide particles.

In an embodiment, the mesoporous particles are made from an element selected from the group comprising of carbon, silicon, aluminum, transition metals, post-transition metals, metalloid elements, lanthanide elements, actinide elements, alkali metal elements, alkaline earth elements, and combinations thereof.

In an embodiment, the mesoporous particles are selected from the group consisting of mesoporous silicate particles, mesoporous metal oxide particles, mesoporous carbon particles, mesoporous metal particles, mesoporous non-oxidic ceramic particles, mesoporous metal calcogenide particles, mesoporous polymer particles, mesoporous organosilica particles, periodic mesoporous organosilica particles, mesoporous metal phosphate particles, and combinations thereof.

In an embodiment, the mesoporous particles are mesoporous oxide particles selected from the group consisting of silica, alumina, zirconia, aluminosilicate, titania, niobia, molybdenum oxide and combinations thereof.

In an embodiment, the high shear mixing is done using ultrasound.

In an embodiment, the method further comprises the step of: dispersing the mesoporous particles in a thermoplastic polymer matrix prior to dispersing in the solvent phase of the casting solution.

The disclosures of the present invention illustrate the surprising unique benefits of particles with a continuous open mesopore structure as additives for the improved performance of polymer filtration membranes for water purification. Without being bound or limited by theory, the open pore structure of the particles contribute to the formation of a greater number of membrane pores during synthesis, as well as to an increase in the polarity of the membrane pore surfaces for greater water permeability.

### BRIEF DESCRIPTION OF THE DRAWINGS

The above, as well as other advantages of the present disclosure, will become readily apparent to those skilled in the art from the following detailed description, particularly when considered in the light of the drawings described herein.

FIG. 1 is an artist's view of polymer strands penetrating the intraparticle pores of a mesoporous silica particles (MSP) mesophase.

FIG. 2 shows an artist's view of the disposition of MSP in filtration membrane pores under conditions where MSPs are embedded in the more porous (left) and less porous (right) areas of the membrane. Penetration of the mesophase pores by polymer strands and particles embedded in the bulk of the polymer are omitted for clarity.

FIG. 3 shows SEM micrographs of the entire cross-section (top row), the separation layer (middle row), and top view (bottom row) of: MSP-free membrane (left column) and of 5% MSP/PSf mesocomposite membrane (middle column), and 10% MSP/PSf mesocomposite membrane (right column) prepared according to the method of Example 1. MSP additive particles can be seen embedded within the separation layer of the MSP/PSf membrane. The scale bars for the two insets are 500 nm.

FIG. 4 shows detailed SEM micrographs of cross-sections of MSP-composite membranes: (Left) PSf composite membrane containing 10% MSP additive (filler) cast by wet-phase inversion in presence of a porogen according to Example 1; (Right) PSf composite membrane containing 10% MSP additive (filler) cast by dry-phase inversion according to Example 2.

FIG. 5 provides a transmission electron microscopy (TEM) image of the MSP derivative used to form the composite compositions of Example 1 with a surfactant-templated mesocellular foam framework structure illustrating the highly open morphology of the particles.

FIG. 6 provides the nitrogen adsorption/desorption isotherms for the surfactant-templated MSP derivative used to form the composite membrane compositions of Example 1. The inset provides the Horvath-Kawazoe pore size distributions obtained from the adsorption (solid curve) and desorption (dashed curve) legs of the nitrogen isotherm.

FIG. 7 provides the nitrogen adsorption/desorption isotherms for the commercially available MSP derivative (HiSil 190™) used to form the composite membrane composition of Example 3. The inset provides the Horvath-Kawazoe pore size distributions obtained from the adsorption (solid curve) and desorption (dashed curve) legs of the nitrogen isotherm.

### DEFINITIONS

To facilitate an understanding of the present invention, a number of terms and phrases are defined below:

MESOPOROUS PARTICLES: According to the International Union of Pure and Applied Chemistry, microporous particles have pore diameters less than 2 nm in diameter, mesoporous particles have 2 to 50 nm pores and macroporous particles have pores greater than 50 nm. A mesoporous particle may also contain micropores with an average diameter less than 2.0 nm, as well as macropores with an average diameter greater than 50 nm. For the purposes of this invention, the particle is mesoporous if at least 20% of the total pore volume as measured by nitrogen adsorption porosimetry is due to the presence of pores with a size in the mesopore range between 2.0 and 50 nm and the small macropore range between 50 and 200 nm. More specifically, the effective pore volume arising from pores in said pore size range of a particle effective in providing a reduction in membrane pore compaction and an increase in water permeability is at least about 0.10 cm³/gram. It should be noted that while the present invention refers to “particles”, whether microporous, mesoporous, or macroporous, it is common in the art to refer to these materials as “solids” as well, and these terms are to be construed interchangeably throughout the present disclosure.

There are two possible types of mesopores, namely, (i) intraparticle mesopores wherein the mesopores are contained within fundamental particles and connect to the external surfaces of the particle and (ii) interparticle mesopores wherein the mesopores are formed through the aggregation of fundamental particles. A mesoporous particle may contain both types of mesopores. Surfactant template MCM-41 silica is an example of a mesoporous particle containing largely intraparticle mesopores. Mesoporous SZSM-5 zeolite is an example of a mesoporous particle that can contains both inter- and intra-particle mesopores. The pore walls of a mesoporous oxide may be crystalline (atomically ordered with atoms positioned on lattice points) or amorphous (lacking in atomic order). Furthermore, the pore network of a mesoporous oxide may be mesostructured and exhibit one or more low angle Bragg X-ray reflections corresponding a pore-to-pore correlation length of 2.0 nm or more, though this is not an essential physical feature of a mesoporous particle.

METAL OXIDE: A solid compound with a composition comprising one or more metallic elements, one or more semi-metallic elements, and mixtures thereof in combination with oxygen.

SILICATE: A solid compound containing silicon covalently bonded to four oxygen centers to form tetrahedral SiO₄ subunits. One or more oxygen atoms of the subunit may bridge to one or more metal centers in the compound. Thus, one or more other elements may be combined with the element oxygen and the element silicon to form a silicate. The solid may be atomically ordered (crystalline) or disordered (amorphous). Silica in hydrated form (empirical formula SiO₂ x H₂O, where x is a number denoting equivalent water content of the composition) or dehydrated form (empirical formula SiO₂) is included in the definition of this term. The compositions of silicates in which one or more other elements are combined with oxygen and silicon to form the compositions may be expressed in dehydrated mixed oxide form. For instance, the composition of a silicate containing aluminum in partial replacement of silicon in tetrahedral positions may be expressed as [SiO₂]₁₋ₓ [Al₂O₃]_{x/2}. A silicate containing aluminum and magnesium whether in tetrahedral or octahedral positions in the oxide may be written [SiO₂]_{1-x-y}[Al₂O₃]_{x/2[MgO]}_{y}. For the purposes of the present art, a silicate composition is one in which the ratio of silicon atoms to each of the remaining electropositive elements defining the composition is equal to or greater than one when the composition is written in dehydrated metal oxide form. For instance, the sodium exchange form of zeolite type A (also known as LTA zeolite) has the empirical dehydrated metal oxide composition [Na₂O]_{0.25}[SiO₂]_{0.50}[Al₂O₃]_{0.25}. Thus, for this silicate, the atomic ratios of Si/Na and Si/Al both are equal to one. That is, the atomic silicon content (Si) of the composition is at least as dominant as any other electropositive element used in describing the composition on a dehydrated metal oxide basis. As another example, the sodium exchange form of montmorillonite clay with the anhydrous metal oxide composition [Na₂O]_{0.40}[Al₂O₃]_{1.6}[MgO]_{0.80}[SiO₂]_{8.0} meets the definition of a silicate because the atomic silicon content of the oxide substantially exceeds the cationic content of each of the other electropositive elements that describe the composition on an anhydrous metal oxide basis (i.e., Si/Na=10, Si/Al=2.5, Si/Mg=10).

ORGANOSILICA is a composition with the anhydrous formula [SiO₂]₁₋ₓ[LSiO_{1.5}]ₓ wherein L is an organogroup linked to silicon through silicon—carbon covalent bonds and x is greater than zero and not greater than 1.0.

PERIODIC MESOPOROUS ORGANOSILICA is a mesostructured composition with the anhydrous formula [SiO₂]₁₋ₓ[SiO_{1.5}—R—SiO_{1.5}]_{0.5}x, wherein R is a bridging organogroup linked to two silicon centers in the pore walls of the mesostructure through covalent silicon-carbon bonds and x is greater than zero and not greater than 1.0.

AN ATOMICALLY ORDERED or CRYSTALLINE SOLID: Refers to a solid in which atoms are arranged on lattice points over a length scale effective in producing Bragg reflections in the wide angle region of the X-ray powder diffraction pattern of the solid which correspond to basal spacings less than 2 nm. Atomically disordered or amorphous solids lack the wide angle diffraction features of a crystalline solid.

WIDE ANGLE DIFFRACTION: refers to the Bragg diffraction features appearing in the two theta region of an X-ray powder diffraction pattern corresponding to one or more basal spacings less than 2 nm in magnitude. Bragg reflections in this region of the diffraction pattern indicate the presence of atomically ordered (crystalline) matter wherein atoms are located on lattice points.

A POROUS SOLID AND SOLIDS WITH ORDERED AND DISORDERED PORES: A porous solid contains open spaces (pores) that can be accessed and occupied through sorptive forces by one or more guest species of molecular dimensions. The said pores may be contained within a single particle of the solid or between aggregates of particles. The pores may be ordered in space and give rise to one or more Bragg reflections in the small angle region of the X-ray powder diffraction pattern, in which case the solid is said to be an “ordered” porous material. If the ordered pores have an average diameter in the mesopore range, the solid is said to be an “ordered mesoporous solid” or “mesostructured” and the ordered pores are said to be “framework” mesopores. If the solid is mesoporous but no Bragg reflections are present in the small angle region of the X-ray diffraction pattern of the compound, the solid is a “disordered” mesoporous solid and the disordered mesopores are said to be “textural mesopores”.

TOTAL PORE VOLUME: For the purposes of this invention the total pore volume per gram of mesoporous solid (also known as the specific pore volume) is taken to be equal to the volume of liquid nitrogen that fills pores at the boiling point of liquid nitrogen and a partial pressure of 0.99 after the material has been out-gassed under vacuum at a temperature of 150° C. for a period of at least four hours. The pore volume under these conditions is taken from the adsorption branch of the nitrogen adsorption-desorption isotherms of the solid after it has been out-gassed under vacuum (10⁻⁶ torr) at 150° C. for a period of 24 hours for the purpose of removing adsorbed water from the pores. One cubic centimeter of liquid nitrogen at the boiling point of nitrogen is equal to 645 cubic centimeters of gaseous nitrogen at standard temperature and pressure (STP).

SURFACE AREA: The surface area per gram of mesoporous solid (also known as the specific surface area) is obtained by fitting the Brunauer-Emmet-Teller or BET equation to the nitrogen adsorption isotherm for the solid at the boiling point of nitrogen.

MESOPORE SIZE: The mesopore size of a mesoporous solid is determined from the pore size distribution obtained from the adsorption and desorption branches of the nitrogen adsorption-desorption isotherms using the Horvath—Kawazoe or HK model (Horvath, G.; Kawazoe, K. J. J. Chem. Eng. Jpn. 1983, 16, 470) or the Barnet-Joyner-Halenda or BJH model for the filling of mesopores. [Barrett, E. P.; Joyner, L. G.; Halenda, P. P. J. Am. Chem. Soc. 1951, 73, 373]. There are many other alternative models for obtaining pore size distributions from nitrogen adsorption isotherms with varying degrees of claimed accuracy, but the above model is commonly used in the literature and is a reasonable approximation of mesopore size. For the purposes of the present invention, we fit the BJH model to both the adsorption and desorption branches of the nitrogen isotherms to obtain the pore size of the mesoporous solid. The peak in the pore distribution curve obtained by fitting the BJH model to the adsorption branch of the isotherm is taken as a measure of the approximate size of the cavities, cages or pores present in the solid. The peak in the pore distribution curve obtained by fitting the model to the desorption branch of the isotherm may be taken as a measure of the approximate size of the windows or necks leading to larger cavities or cages in the solid. For the purposes of this invention, either measurement is used to identify a mesoporous additive. Although the International Union of Pure and Applied Chemistry (IUPAC) Convention has limited the definition of mesoporosity to pores in the 2 to 50 nm size range, for the purposes of this invention we extend the definition to a pore size range of 2 to 200 nm as materials with pores in the range 50 to 200 nm are especially useful.

MESOSTRUCTURED: This term refers to a structured form of a solid wherein the element of structure repeats on a length scale greater than 2 nm, resulting in the presence of at least one Bragg reflection in the small angle X-ray powder diffraction pattern of the solid. The repeating element of structure may be atomically ordered (crystalline) or disordered (amorphous). In the case of ordered mesoporous (mesostructured) solids, the pores and pore walls represent the element of structure that gives rise to Bragg reflections in the small angle X-ray diffraction pattern of the solid. The mesostructured materials for the composite compositions of the present invention may be crystalline or amorphous, bear electrically charged or uncharged surfaces, and exhibit 1D, 2D, or 3D framework pore structures with hexagonal, cubic, lamellar, mesocellular foam or wormhole symmetry, or no pore symmetry whatsoever, except that the pore structure is open, continuous and effective in facilitating the passage of water through the composite membrane.

SMALL ANGLE DIFFRACTION: refers to the Bragg diffraction features in the two theta region of an X-ray powder diffraction pattern corresponding to one or more basal spacings greater than 2.0 nm in magnitude.

MESOCELLULAR SILICA FOAM: a surfactant templated mesoporous silicate composition wherein the porosity results from the presence of silicate struts that define cage-like cellular pores connected by windows (pore openings) and wherein the average diameter of the windows is smaller than the average diameter of the cages. Examples include silica compositions denoted MCF silica and MSU-F silica in the scientific literature.

WORMHOLE FRAMEWORK or WORMHOLE MESOSTRUCTURE: A surfactant-templated mesostructured solid wherein the porosity results from the presence of intersecting, channel-like intra-particle pores with a pore-to-pore correlation distance effective in providing at least one Bragg diffraction feature in the small angle X-ray powder diffraction pattern of the solid. Examples include silica compositions denoted in the literature as HMS silica and MSU-J silica.

POROGEN: an agent that may form a pore in a material. Specifically, a porogen may be a specific chemical utilized to form pores in particles, such as metal oxides or in polymer membranes such as the polymer filtration membranes defined herein. For example, surfactant micelles may be utilized to form pores in particles such as metal oxides to form mesoporous particles and are sacrificial because these agents are removed to allow the pores to be accessible to other components. Alternatively, a porogen may be a specific agent, such as polyethylene glycol or polyvinylpyrrolidone utilized to form pores in polymer filtration membranes and are sacrificial because the agents are removed to allow the pores to be permeable. In this sense, the mesoporous particles used to form polymer composite membranes, as disclosed herein, are porogens. The mesoporous particles remain as part of the final composition in the membranes of the present invention and are not sacrificial. The particular porogen utilized in each instance should be apparent to one having ordinary skill in the art.

### DETAILED DESCRIPTION OF THE PRESENTLY PREFERRED EMBODIMENTS

The following description is merely exemplary in nature and is not intended to limit the present disclosure, application, or uses. It should also be understood that throughout the reference numerals indicate like or corresponding parts and features. In respect of the methods disclosed, the order of the steps presented is exemplary in nature, and thus, is not necessary or critical, unless otherwise noted. In addition, while much of the present invention is illustrated using specific examples, the present invention is not limited to these embodiments. All publications, patent applications, patents, and other references mentioned herein are incorporated by reference in their entireties. In case of conflict, the present specification, including definitions, will control.

This invention embodies polymer membrane composites containing one or more mesoporous particle additives selected from the group comprising mesoporous silicate particles (MSP), mesoporous metal oxide particles (MOP), mesoporous carbon particles (MCP), mesoporous metal particles (MMP), mesoporous non-oxidic ceramic particles (MNO) such as silicon carbide, silicon nitride, and silicon carbide nitride, mesoporous metal calcogenide (MMC) particles, mesoporous polymer particles (MPP), mesoporous organosilica (MOS) particles, periodic mesoporous organosilica (PMO) particles, mesoporous metal phosphate (MMF) particles, and combinations thereof.

More specifically, this invention embodies a polymer membrane composite composition comprising one or more mesoporous particle additives selected from the group comprising a mesoporous silicate, a mesoporous metal oxide, a mesoporous carbon, a mesoporous metal, a mesoporous non-oxidic ceramic, a mesoporous metal chalcogenide, a mesoporous polymer, a mesoporous organosilica, a periodic mesoporous organosilica, mesoporous metal phosphate, and combinations thereof, wherein the loading of the mesoporous additive is between 0.10% and 50% on a weight basis. Furthermore this invention embodies said composite compositions wherein the mesoporous particle additive is effective in increasing the water permeability, decreasing the molecular weight cutoff, or decreasing the compaction of the composite membrane in comparison to the membrane without the additive. Any one of the said properties is desirable in improving the purification of water by membrane filtration methods.

Each group of particle additives of this invention is characterized by a pore size distribution in which the maximum in the Horvath-Kawazoe distribution curve, as determined from either the adsorption or desorption leg of the nitrogen adsorption/desorption isotherms, is centered between 2.0 and 200 nm. The maximum value in a pore size distribution curve is taken to be the “average pore size” of the material. At least 20% of the total pore volume for the mesoporous material is due to pore sizes in the range 2.0 to 200 nm. The preferred particle size range for the additives is 10 nanometers to 50 micrometers, whether in the form of fundamental particles or particle aggregates. Most preferred are particles in the sub-micrometer range 100 to 1000 nm. The preferred mesoporous particle loading in the polymer membrane is in the range 0.1 to 50 wt %. The most preferred loadings are in the range 0.5 to 10 wt %.

This invention further embodies composite compositions of polymer membranes used in ultrafiltration, nanofiltration, and reverse osmosis water treatment processes. Polymeric membranes are commonly made of the following polymers: poly(ether sulfone), polysulfone, poly(vinylidene difluoride), poly(vinyl chloride)—polyacrylonitrile copolymers, polyacrylonitrile cellulose acetate, polyamides (aromatic), cellulose acetate, polypropylene and polyethylene. Mesoporous particle composites of these polymeric membranes may be made by several different processes, including, for example, liquid phase inversion processes (also known as a wet phase inversion processes), phase inversion during compounding processes, and an interfacial polycondensation reaction process [http://www. stanford.edu/group/ees/rows/presentations/Ridgway.pdf]. The Loeb-Sourirajan process is an effective phase inversion process for preparing the mesoporous particle composite membranes of this invention, though the invention is not limited to this process alone. The Loeb-Sourirajan process involves exposing a solution of a polymer to a non-solvent and separation of the single phase into two phases—polymer rich and polymer-poor. The polymer rich phase precipitates forming a free-standing polymeric membrane. Poly(vinyl methyl ether) or poly(vinyl pyrrolidone) are often added to the casting solutions of more hydrophobic polymers (polysulfone, poly(vinylidene difluoride)) to increase hydrophilicity of cast membranes in order to improve fouling resistance.

Still further, this invention embodies polymer membrane compositions containing a mesoporous particle additive and one or more additives of complementary hierarchical structure (e.g., layered materials such as graphene sheets or exfoliated nanoclays) or complementary function (e.g., microporous materials such as zeolites). Graphene sheets, for example, can contribute synergistically to the reinforcement of the polymer membrane and assist in reducing the degree of pore compaction. The basal surfaces of graphene sheets also may also be used for immobilizing catalysts centers (e.g., metal complexes, metal atom clusters and metal nanoparticles) for the chemical transformation of water soluble pollutants under ambient conditions. Such immobilized metal centers (e.g., silver nanoparticles) may also serve as biocides and reduce the degree membrane fouling by bacteria. Membrane composites containing nanoporous zeolites as a co-additive can provide ion-exchange functionality, as well as catalytic functionality.

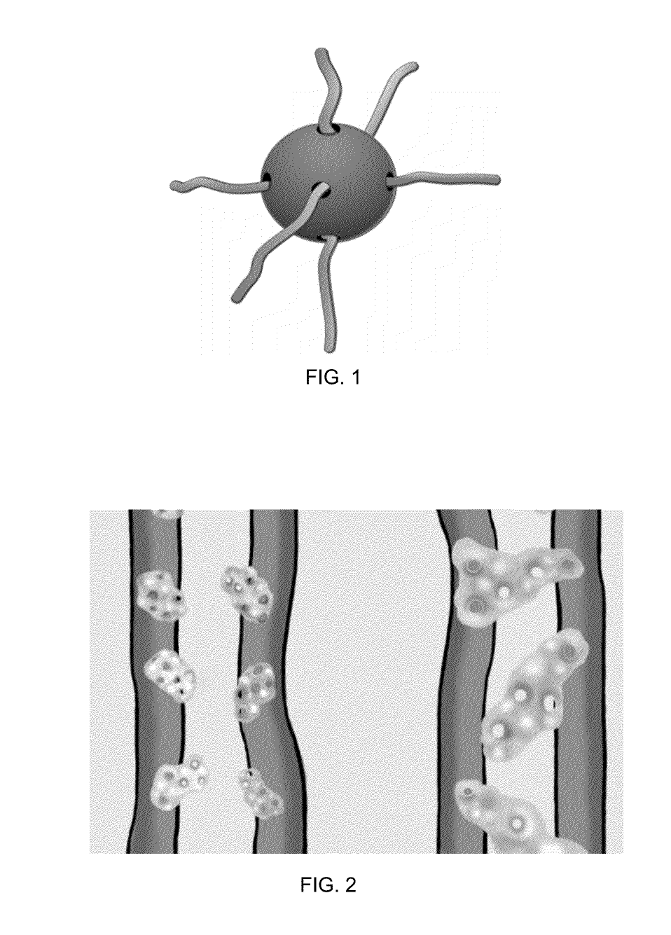

Without being bound or limited by theory, because the pores of mesoporous particles are larger than the van der Waals diameter of the polymer chains, the polymer may penetrate at least in part the particle pores and adsorb to the internal surfaces of the mesophase, as shown by the artist's rendition in FIG. 1. The cumulative polymer-particle interfacial interactions may surpass those occurring between polymer and the external surfaces of conventional non-porous reinforcement additives of the same size, thereby providing superior reinforcement to the polymer matrix. For instance, the tensile strength and modulus of a rubbery epoxy matrix may be increased 2.7- and 3.2-fold, respectively through the incorporation of 5.0 wt % of MSP in the matrix [Jiao, J., X. Sun, and T. J. Pinnavaia, Mesoporous silica for the reinforcement of rubbery and glassy epoxy polymers. Polymer, 2009. 50 (4): p. 983-989.

The strength and modulus of even a glassy epoxy matrix may be increased by 18% and 31%, respectively, at an equivalent MSP loading. Non-porous particles, such as widely investigated nanoclays, may also provide polymer reinforcement, but the degree of reinforcement is inferior in comparison to MSP additives.

The increase in polymer density that may accompany the mesoporous particle reinforcement of the polymer matrix may also make the membrane more stable, both chemically and thermally, as well as less prone to shedding of the particles when in use.

In one embodiment of the present invention, and without being bound by theory, the membrane polymer may partially occupy the pores of the mesoporous particle additive in order to take advantage of the hydrophilicity of the pore surfaces for fouling reduction and flow enhancement. Mesopore penetration by the polymer may be made possible due to the comparison of the average hydrodynamic diameter of molecules of polysulfone dissolved in N-methylpyrrolidone (measured via light scattering tests to be 8 nm) and much larger pore size of the mesoporous particle additive. That is, the coverage of the mesoporous particle additive pore surfaces by polymer may be balanced with respect to providing reinforcement and reduced compaction on the one hand and hydrophilicity for improved water permeability and fouling resistance on the other.

In addition to functioning as reinforcing agents, mesoporous particles may increase the hydrophilicity of the membrane, thus increasing permeability and resistance to fouling. As illustrated in FIG. 2 (left) and without being bound by theory, under conditions where the particle size of the additive may be smaller than the membrane pores, the mesoporous particles may line the walls of the membrane and may contribute to the overall permeability by facilitating water flow through more hydrophilic pores than those of the host polymer. When the mesoporous particles may be embedded close to or within the separation layer under conditions where the membrane pores may be small in comparison to the size of the particles (see FIG. 2, right), the particles may facilitate water transport through the internal channels of the particles and thereby may generate greater membrane porosity. Although polymer strands may occupy the pores and provide reinforcement, pore occupancy may be incomplete under the conditions used to fabricate the membrane composite. Thus, the particle pore surfaces may remain hydrophilic and water transport through the pores may remain facile. Under either set of particle size to membrane pore size conditions, percolation behavior may become possible and correspondingly greater permeability may be obtained at higher loadings. Increased hydrophilicity is known to reduce fouling of membranes as stronger binding of water molecules to more hydrophilic surfaces may inhibit attachment of foulants.

As illustrated in Example 1 below, a two-fold increase in permeability is observed for a polysulfone composite containing a 5.0 wt % loading of an MSP additive in comparison to the additive-free membrane. In addition, the separation fidelity of the membrane is substantially increased, as indicated by a decrease in molecular weight cutoff from 80 kDa for the pure polymer to 24 kDa for the 5 wt % composite. Importantly, the resistance to compression also improves by an order of magnitude. The increase in filtration fidelity is surprising because the increased flux was realized despite the decrease in membrane pore size, as reflected in the decrease in molecular weight cutoff. Normally, an increase in flux occurs due to an increase in membrane pore size and a concomitant reduction in separation fidelity.

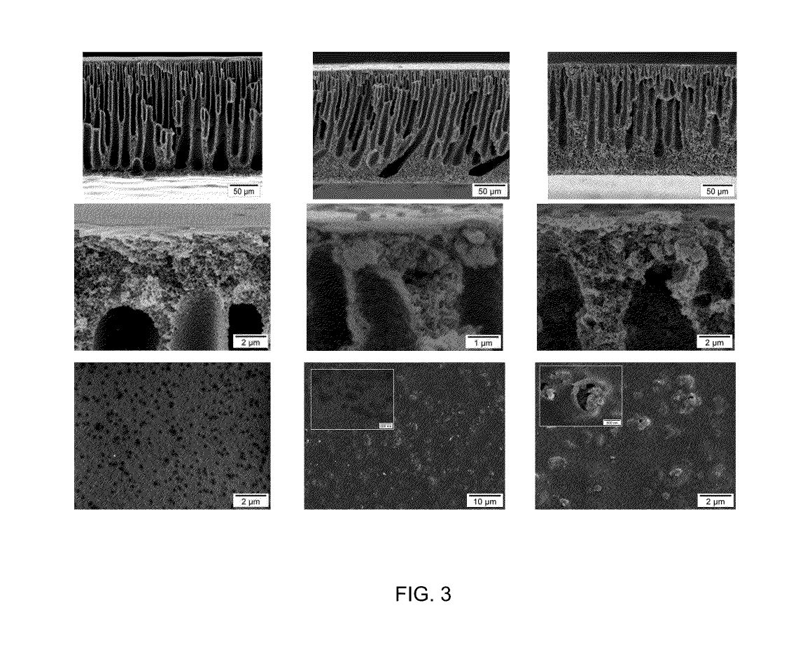

Scanning Electron Microscopy (SEM) images of the polysulfone/MSP composite compositions made according to Example 1 indicate that the addition of the mesoporous particle additive leads to the suppression of macrovoid formation and densification of the membrane (compare the images in the top row of FIG. 3). Without being limited by theory, the observed dramatic improvement in membranes compaction resistance is attributed, in part, to these morphological changes. A homogeneous distribution of the mesoporous particle additive is observed across the entire cross-section of the membrane, including the portion of the porous support just under the skin layer (see the middle row of images in FIG. 3). The size of membrane surface pores (see the bottom row of images in FIG. 3) decreases with an increase in mesoporous particle loading. In fact, pores in the skin of a 10% MSP/polysulfone composite membrane are barely resolved (see FIG. 3, bottom row, right column). However, the inset in the SEM image of the top surface of the 10% MSP/polysulfone membrane shows surface defects, which are attributable to air trapped in the internal pores of the mesoporous additive. In one embodiment, such defects may be obviated by degassing the MSP/NMP organosol to drive the air out of the pores prior to adding polymer to form the casting mixture.

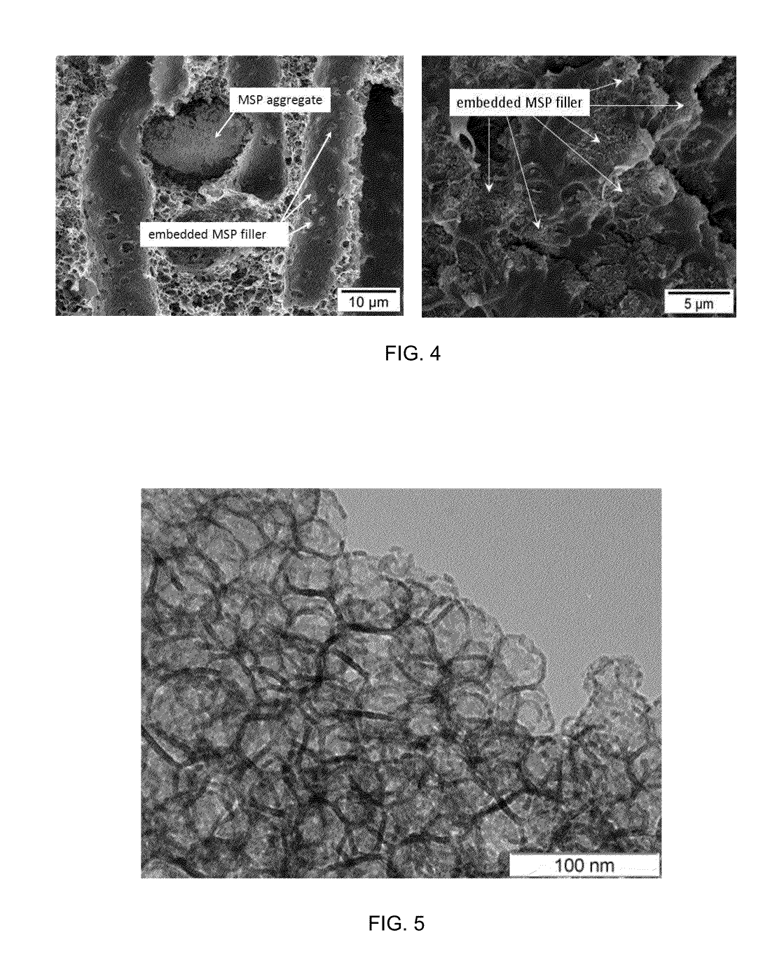

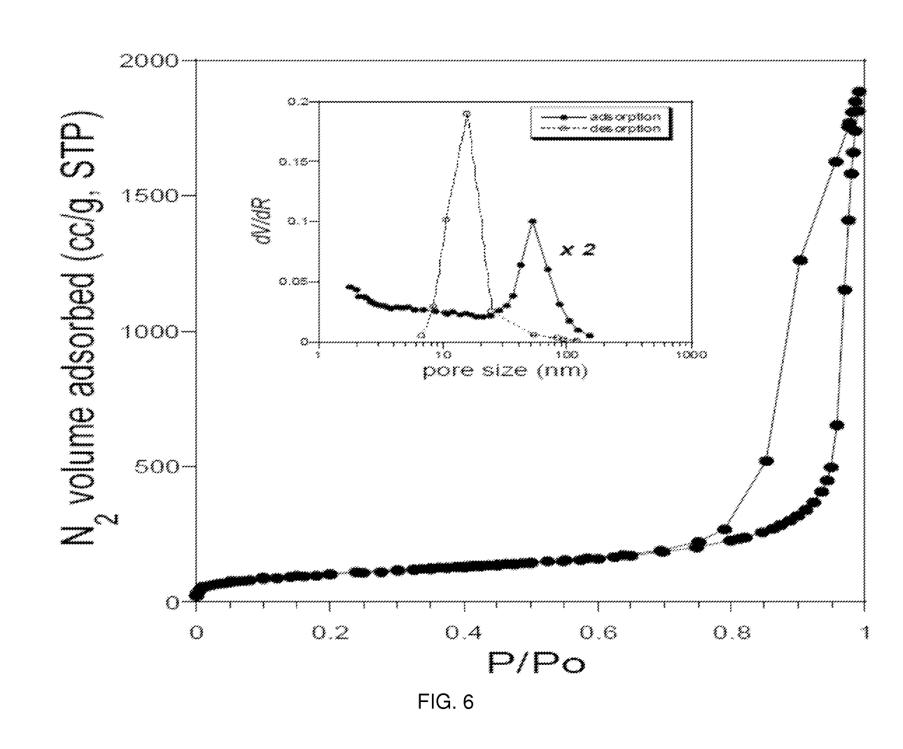

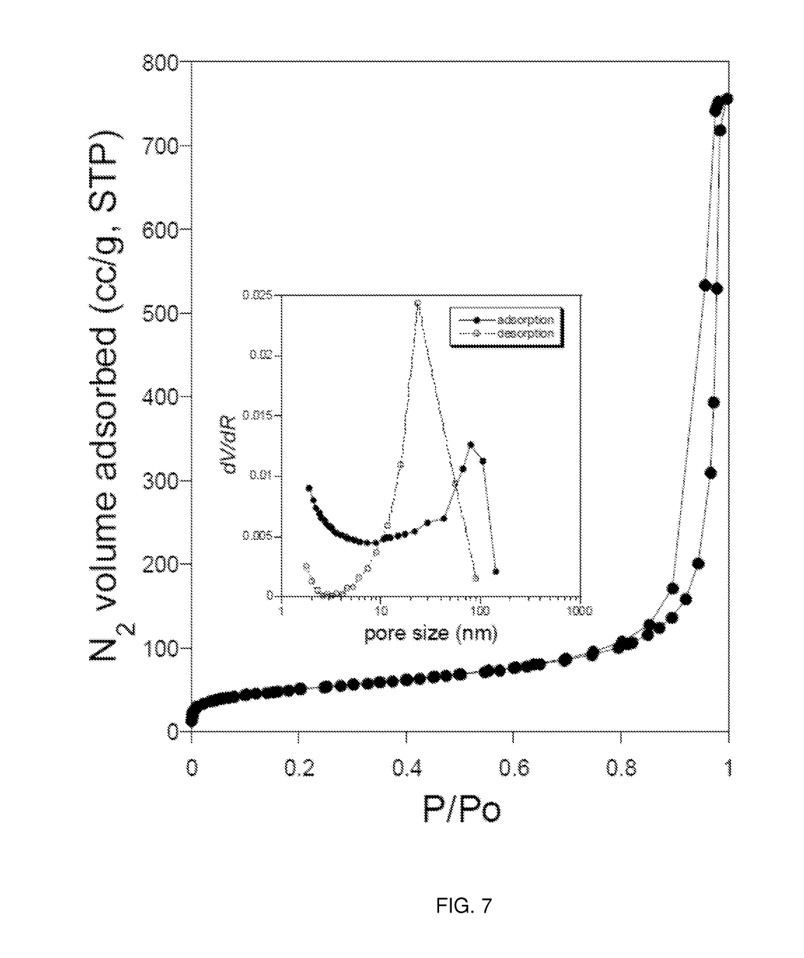

In order to provide reinforcement while at the same time preserving surface hydrophilicity for optimal water flow through the mesoporous particle pores, it may be desirable to mediate the extent of polymer-particle interactions in the composite membrane. Having the particle pores entirely filled by polymer may preclude transport of water through the particle pores. Thus, the occupancy of the particle pores by polymer may preferably be balanced to provide both reinforcement and open hydrophilic pores for water transport. The partitioning of polymer between the additive pores and the membrane casting solution may provide a means for mediating particle mesopore occupancy. Whereas a fraction of mesoporous additive particles may be embedded into the polymer membrane matrix, larger aggregates not attached to the host polymer may be lodged within membrane micropores (see the SEM images in FIG. 4 for the 5 wt % and 10 wt % MSP/PSf made according to Example 1). Such aggregation may be minimized by employing the following strategies aimed at improved wetting of mesoporous particle additive by the solvent and a better dispersion of mesoporous particles: 1) degassing of the particle/solvent organosol to remove air captured within mesoporous particle pores, allowing the polymer to more readily wet the particle by entering the particle mesopores, 2) high intensity ultrasound sonication, high sheer mixing or a combination thereof to decrease mesoporous particle aggregate size in the solvent/particle organosol, 3) melt processing a mixture of mesoporous particles and membrane polymer to reduce particle agglomeration prior to forming the solvent/particle organosol, 4) casting the membrane using a combination of dry phase inversion and wet phase inversion in the absence of porogens to avoid or minimize the competitive sorption of polar non-solvent (e.g., water) and porogen (e.g., polyethylene glycol, polyvinyl pyrrolidone) on the mesoporous particle surface from the casting solution, 5) calcining the mesoporous particle at higher temperatures to further dehydroxylate the surface and improve particle-polymer affinity, 6) and providing electrically neutral or electrically charged (ionic) organofunctional moieties on the particle surfaces through known methods including physical adsorption, coupling reactions between surface hydroxyl groups and a coupling reagent such as silanes (i.e., grafting reactions) or through the incorporation of the organofuctional group in the pore walls of the as-made mesophase. Another approach for manipulating reinforcement and flux increase may independently employ the addition of mixtures of mesoporous particles with different pores sizes.

Mesoporous Silicate Particles (MSP):

MSP derivatives are members of a broader class of mesoporous metal oxide particle (MOP) derivatives, but owing to their versatile structures and exceptional range of surface areas, pore sizes, and pore volumes, they are identified herein as a specific class of mesoporous particle additives for filtration membranes with improved performance properties. The desired pore architectures of this class of mesoporous particles may be realized through two processes, namely, the precipitation of silica from sodium silicate solutions through the addition of a mineral acid (so-called precipitated silicas) [http://en.wikipedia.org/wiki/precipitated_silica] and through supramolecular assembly processes in which surfactant micelles are used as porogens (so-called mesostructured silicas or surfactant-templated silicas). The incorporation of aluminum, phosphorus and other elements apparent to one of ordinary skill in the art into the silica framework affords aluminosilicates [Solid-state NMR study of ordered mesoporous aluminosilicate MCM-41 synthesized on a liquid-crystal template, Kolodziejski W; Corma A; Navarro M T; Perez-Pariente J Solid state nuclear magnetic resonance 1993, 2(5), 253-9], phosphosilicates [Ordered mesoporous phosphosilicate glass electrolyte film with low area specific resistivity Li Haibin; Nogami Masayuki Chemical communications 2003, (2), 236-7], among other silicate derivatives such as zeolites.

Mesoporous aluminosilicates exhibit ion exchange properties which may be used to impart specific functions such as catalytic function or ion exchange properties to polymer membrane composites containing mesoporous silicate particles [see “Ammonium ions removal from aqueous solutions using mesoporous (Al)Si-MCM-41” Copcia, V. Elena; L., Camelia E.; Bilba, N. Environmental Engineering and Management Journal 2010, 9(9), 1243-1250].

MSP additives made by surfactant templating are amorphous, yet they typically exhibit low angle Bragg X-ray scattering indicative of a regularly ordered pore structure. MSP additives can have 1D, 2D, and 3D pore structures with overall hexagonal, cubic, lamellar, foam, or wormhole framework pore structure, depending on the nature of the surfactant micelles used a porogens (e.g., cationic, anionic, electrically neutral surfactants) and the reaction conditions (e.g., temperature, reagent concentration).

In general, MSP additives, whether precipitated or surfactant templated, exhibit specific surface areas of 5-1500 m²/g, pore sizes in the range 2-200 nm and pore volumes of 0.20-3.5 cm³/g. However, surfactant templated forms of MSP exhibit far more uniform pore size distributions, higher surface areas, and greater pore volumes as compared to precipitated silicas. The primary particle size of MSP additives typically is 5-500 nm and the agglomerate size is 1-150 μm. As with surfactant-templated silicates, mesoporous precipitated silicas are amorphous. But unlike surfactant-templated silicates, they do not exhibit a low angle X-ray diffraction line, indicating a lack of long range pore ordering.

Mesoporous Metal Oxide Particles (MOP):

As in the case of MSP additives, MOP additives can be prepared through precipitation from aqueous solution or through supramolecular assembly processes using surfactant porogens. Surfactant templated MOP additives are preferred as they typically provide higher specific surface areas, more uniform pore size distributions, and higher pore volumes in comparison to precipitated metal oxides. Most preferred are crystalline MOP derivatives made through surfactant templated assembly. Representative examples include mesoporous transition aluminas (300-450 m²/g surface area; ˜2 nm pore size, 0.30-0.40 cm³/g pore volume), mesoporous anatase titania (50-100 m²/g surface area; 5-10 nm pore size, 0.10-0.20 cm³/g pore volume), mesoporous zirconia (10-250 m²/g surface area; ˜2-nm pore size, up to 3.0 cm³/g pore volume), mesoporous niobia (40-250 m²/g surface area; 5-22 nm pore size, 0.10-0.30 cm³/g pore volume) [Z. Zhang; T. J. Pinnavaia, “Mesostructured Forms of the Transition Phases η- and χ-Al₂O₃x” Angew. Chem. Int. Ed. 2008, 47, 7501-7504; S. Shamaila, et al. “Mesoporous titania with high crystallinity during synthesis by dual template system as an efficient photocatalyst” Catalysis Today, 2011, 175, 568-575; S. Y. Chen, L. Y. Jang, and S. Cheng, “Synthesis of Thermally Stable Zirconia-Based Mesoporous Materials via a FacilePost-treatment” J. Phys. Chem. B 2006, 110, 11761-11771; L. Yuan, V. V. Guliants “Mesoporous niobium oxides with tailored pore structures” J. Mater. Sci., 2008, 43, 6278-6284]. In addition to the mesoporous transition aluminas (i.e., gamma-, eta-, chi-, kappa-, delta-, and theta-alumina), other effective forms of mesoporous alumina include amorphous alumina, and the hydrated aluminas known as aluminum trihydrate (also known as gibbsite) and as boehmite. In addition to mesoporous anatase titania, zirconia, and niobia, other transition metal oxides useful as a filtration membrane additive include rutile titania, amorphous titania and other transition metal oxides such as molybdenum oxide, post-transition metal oxides such as germanium oxide, lanthanide oxides such as lanthanum oxide such as lanthanum oxide or cerium oxide and actinide oxides such as thorium oxide, in both amorphous and crystalline form.

Mesoporous Carbon Particles (MCP):

MCP are yet another preferred group of additives effective for the reinforcement and improved filtration properties of filtration membranes. These materials can be obtained through the replication of mesoporous silica particles, the colloid imprinting processes, and through organic-organic assembly processes. The replication of mesoporous SBA-15 silica using sucrose as the carbon source affords a mesoporous carbon with the following textural parameters: 1520 m²/g surface area; 4.5 nm pore size, 1.3 cm³/g pore volume [S. Jun et al. “Synthesis of New, Nanoporous Carbon with Hexagonally Ordered Mesostructure” J. Am. Chem. Soc. 2000, 122, 10712-10713]. Colloid-imprinted carbons made from colloidal silica as the templating agent and pitch as the carbon source exhibit the following textural properties: 60-235 m²/g surface areas, 13-90 nm average pore sizes, and pore volumes in the range 0.40-0.65 cm³/g [S. S. Kim, J. Shah, T. J. Pinnavaia “Colloid-Imprinted Carbons as Templates for the Nano-casting Synthesis of Mesoporous ZSM-5 Zeolite” Chem. Mater. 2003, 15, 1664-1668]. The high temperature thermolysis of mesoporous organic polymers prepared by organic-organic self-assembly exhibit the following textural properties: 675-780 m²/g surface areas, 3.8-4.6 nm average pore sizes, and pore volumes in the range 0.52-0.72 cm³/g [P. Gao, A. Wang, X. Wang, T. Zhang “Synthesis of Highly Ordered Ir-Containing Mesoporous Carbon Materials by Organic—Organic Self-Assembly” Chem. Mater. 2008, 20, 1881-1888; Liang, C. D. et al., Angew. Chem. Int. ed. 2004, 43, 5785; Tananka, S. et al. Chem. Commun. 2005, 2125].

Mesoporous Polymer Particles (MPP):

Mesoporous polymer particles are another preferred group of additives effective for the improved performance of filtration membranes. These particles typically can be prepared by organic—organic templating methods wherein a polymer resin (e.g., a phenolic) and a templating polymer (e.g., a polyethylene oxide polypropylene oxide block co-polymer) interact to form a hybrid mesophase. The removal of the templating polymer by low temperature thermolysis affords a mesoporous form of the more thermally stable polymer resin. [Y. Meng et al. “A Family of Highly Ordered Mesoporous Polymer Resin and Carbon Structures from Organic-Organic Self-Assembly” Chem. Mater. 2006, 18, 4447-4464]. Mesoporous phenolic polymers are known with surface areas up to 670 m²/g, pore sizes up to 7.1 nm and pore volumes up to 0.65 cm³/g.

Other Mesoporous Particles:

Mesoporous non-oxide ceramic particles (MNO) such as silicon carbide, silicon nitride, and silicon carbide nitride [J. Yan et al. “Preparation of ordered mesoporous SiCN ceramics with large surface area and high thermal stability”, Microporous Mesoporous Mater. 2007, 100, 128-133], mesoporous metal calcogenide (MMC) particles Armatas, G. S.; Kanatzidis, M. G. “Mesoporous germanium-rich chalcogenido frameworks with highly polarizable surfaces and relevance to gas separation” Nature Materials 2009, 8(3), 217-222], and mesoporous metals particles (MMP) [Scott, W. and Wiesner, U. “Self-assembled ordered mesoporous metals” Pure Appl. Chem. 2009, 81, 73-84] also are recognized as materials effective as additives for improving the permeability and selectivity of polymer membranes. Still further, periodic mesoporous organosilica (PMO) [T. Asefa et al. “Periodic mesoporous organosilicas with organogroups inside the cannel walls” Nature 1999, 402, 867-871], mesoporous organosilica (MOS) particles [J. Shah et al. “A versatile pathway for the direct assembly of organo-functional mesostructures from sodium silicate.” Chem. Commun. 2004, 572-573] and mesoporous metal phosphate particles [U. Ciesla et al. “Formation of a porous zirconium oxophosphate with a high surface area by a surfactant-assisted synthesis” Angew. Chem. Int. Edn Engl. 1996 35, 541-543] are additional families of additives effective in improving the permeability and selectivity of polymer membranes.

### EXAMPLES

The following General Methodology and examples specified herein are for illustrative purposes only and are not meant to limit the scope of the invention as detailed herein. Examples 1-6 disclose membranes formed without the presence of mesoporous particles. Example 7 specifies exemplary embodiments of the present invention of the membranes made according to Examples 1-6 with the presence of mesoporous particles, according to the present invention.

General Methodology

Neat and composite ultrafiltration (UF) membranes were prepared by a wet phase inversion process. In a typical composite membrane preparation, the desired amount of mesoporous metal oxide additive, as described herein, was suspended in a solvent phase (for example, N-methylpyrrolidone (NMP) or dimethylacetamide (DMAC)) and the mixture was subjected to high-shear mixing, or more preferably, ultrasound using a bath or horn sonicator, to disperse the particles from an aggregated size of tens of micrometers to a fundamental sized of less than about 10 μm, more typically less than about 1.0 μm. The polymer was dissolved in the suspension containing an optional quantity of porogen (for example, polyethylene glycol with an average molecular weight of about 400 Da (PEG-400) or polyvinylpyrrolidone (PVP) with a molecular weight of about 40 KDa). As an alternative to the use of high-shear mixing to achieve particle dispersion, the metal oxide additive and polymer were thermally compounded on a bench tom DSM extruder at 320° C. and 230° C., the cases of PSF and PVDF, respectively. The compounded polymer mixture was then dissolved in the solvent phase.

The concentration of polymer in the casting phase may generally range from about 0.1 wt % and about 50 wt %, more preferably between about 10 wt % and 40 wt %, and most preferably between about 15 wt % and 20 wt %. In order to form the membranes, the solutions were manually cast onto a glass plate with the casting knife adjusted to about 300 μm thickness, followed by immersion of the plate and the cast film into a non-solvent coagulation bath of deionized water. The wet phase-inverted UF membranes were removed from the bath and rinsed thoroughly. The final membranes were stored under water in a refrigerator. For long term storage of membranes made according to the present methodology, the membranes were immersed in a 1.5 wt. % sodium meta-bisulfite solution to prevent bacterial growth on the membranes.

A Millipore Stirred Ultrafiltration 8050 dead-end filtration cell suitable for mounting a membrane specimen 44.5 mm in diameter was used to measure pure water flux. The resistivity of the water was 18.2 MΩ. The rejection measurements were performed in a Stirred Millipore Ultrafiltration 8010 dead-end flow cell suitable for mounting a membrane specimen 25 mm in diameter. Aqueous 0.5 g/L solutions of Dextran polysaccharides with molecular weight values of 12, 25 and 80 kDa; and of bovine serum albumin (BSA) with a molecular weight of 66 kDa were used as the rejection probes. The rejection solution was filtered under applied pressure (typically from between about 14.5 psi to about 40 psi) through a membrane previously compacted during permeability testing. For Dextran as the rejection probe, the concentration in the feed and permeate streams was determined using a total organic carbon analyzer (Model 1010, OI Analytical). For concentrations of feed, permeate, and concentrate solutions were read from a reference plot of absorbance vs. concentration. The rejection probe was calculated using the following equation:

$$R \% = 100 \times ( 1 - \frac{{C}_{p}}{( {C}_{f} + {C}_{c} ) / 2} ) I .$$

where C_{f}, Cₚ and C_{c} are concentrations of probe molecules in feed, permeate and concentrate solutions, respectively.

### Example 1

Example 1 illustrates the preparation and flux and rejection properties of a relatively dense polysulfone (PSF) UF membrane. The membrane was made from a 20 wt % solution of polymer in a solvent plus porogen casting solution. The membrane solution was prepared by dissolving 3.0 g of PSF (UDEL P-3500, Solvay Specialty) in 9.75 g of N-methylpyrrolidone (NMP) as a solvent, and 2.25 g of polyethylene glycol (PEG-400) as a porogen under magnetic stirring or shaker bath conditions at 60° C. for a period of 18 hours. The casting solution was loaded into a casting knife and a film was manually drawn on a glass plate. Following an aging period of a few seconds to a few minutes, the film and glass plate were submerged in a water bath to achieve phase inversion and the separation of the membrane from the glass plate. The membrane was washed in flowing water for a period of 20 minutes. During this time, the membrane wash bath was refreshed by emptying and filling with fresh water every 5 minutes. The pure water flux under an applied pressure of 40 psi was 0.74 L/m²/bar. The rejection of 12 kDa Dextra was 29%.

### Example 2

Example 2 illustrates the preparation and pure water flux of a neat PSF UF membrane prepared without the use of a porogen. The membrane was made from a solvent solution containing 20 wt % polymer. The membrane solution was prepared by dissolving 3.0 g of PSF (Udel P-3500, Solvay Specialty) in 12.0 g of NMP. The procedures for preparing the casting solution, casing the membrane and determining pure water flux were the same as described in Example 1. The pure water flux was found to be 0.19 L/m²/bar. The flux was too low to warrant a rejection measurement.

### Example 3

Example 3 illustrates the preparation, pure water flux, and rejection properties of a relatively high permeability PSF UF membrane prepared without the use of a porogen. The membrane of Example 3 was made from a solvent casting solution containing about 15 wt % polymer. The membrane solution was prepared by dissolving 2.25 g of PSF in 12.75 g NMP. The procedures for preparing the casting solution and casting the membrane were the same as described in Example 1. The methods used to determine pure water flux and rejection were the same as described in Example 1. The pure water flux was found to be 26 L/m²/bar. The rejection of 12 kDa Dextran was 22%, and the rejection of 66 kDa BSA was 93.9%.

### Example 4

Example 4 illustrates the preparation and relatively low pure water flux and rejection properties of a neat BASF Ultrason E6020P polyethersulfone (PES) UF membrane prepared in the presence of a porogen casting solution containing 20 wt % polymer. The membrane was made from a solvent plus porogen casting solution. The membrane solution was prepared by dissolving 3.0 g PES in 9.75 g NMP and 2.26 g PEG-400. The procedure for preparing the casting solution and for casting the membrane was the same as described in Example 1. The methods used to determine pure water flux and rejection were the same as described in Example 1. The pure water flux was found to be 4.2 L/m²/bar. The rejection of 12 kDa Dextran was 28.7%.

### Example 5

Example 5 illustrates the preparation and relatively high flux and rejection properties of a neat PES (BASH, Ultrason E6020P) UF membrane. The membrane was made from a solvent plus porogen casting solution containing 15 wt % polymer. The membrane solution was prepared by dissolving 2.25 g PES and 0.75 g PVP in 12.0 g NMP. The procedure for preparing the casting solution and for casting the membrane was the same as described in Example 1. The methods used to determine pure water flux and rejection were the same as described in Example 1. The pure water flux was found to be 444 L/m²/bar and the rejection of 66 kDa BSA was 95.7%.

### Example 6

Example 6 illustrates the preparation, pure water flux, and rejection properties of a neat PVDF membrane. The membrane was made from a solvent casting solution containing 20 wt % polymer and no porogen. The casting solution was prepared by dissolving 3.0 g PVDF (Arkema) in 12.0 g dimethylacetamide (DMAC). The procedure for preparing the casting solution and casting the membrane was the same as described in Example 1. The methods used to determine pure water flux and rejection were the same as described in Example 1, except the pressure was at 14.5 psi. The pure water flux was 3.3 L/m²/bar. The rejection of 12 kDa Dextran was 35%

### Example 7

Example 7 illustrates the preparation and pure water flux and rejection properties of PSF, PES, and PVDF composite membranes containing mesoporous forms of silica, alumina, zirconia, and a synthetic layered aluminosilicate, pursuant to the present invention, and made according to the methods specified in Examples 1-6. The textural properties of these additives are provided in Table 1. The BET surface area, BJH pore size, and pore volume reported in Table 1 were determined by nitrogen porosymmetry using a Micromeritics Tristar. The average particle size of the oxide samples in water dispersion was determined by laser diffraction using a Malvern Instrument Masterizer 2000 Model BPA 2000 particle size analyzer.

TABLE 1
Textural Properties of Mesoporous Oxide
Particles Used in the Examples

| | | | | Total | |
|---|---|---|---|---|---|
| | | Surface | Ave. | Pore | Sonified |
| Mesoporous | Sample | Area, | Pore | Volume, | Particle |
| Oxide | ID | m²/g | Size, nm | cm³/g | Size (μm) |
| Mesocellular | FE 110701 | 354 | 52.8 | 2.92 | 0.14 |
| Foam Silica | | | | | |
| Mesocellular | FE110719 | 135 | 53.3 | 1.0 | 0.14 |
| Foam Silica | | | | | |
| Mesocellular | FE120509 | 272 | 42 | 2.0 | 4.4 |
| Foam Silica | | | | | |
| Mesocellular | FE120711 | 459 | 20.5 | 2.00 | 0.16 |
| Foam Silica | | | | | |
| Mesocellular | FE100602 | 367 | 23.6 | 2.10 | 0.18 |
| Foam Silica | | | | | |
| Organo- | 10% Ph- | 373 | 15.1 | 1.88 | — |
| functional | F120724EE | | | | |
| Mesocellular | | | | | |
| Foam Silica, | | | | | |
| 10% phenyl | | | | | |
| silylation | | | | | |
| Hexagonal | MCM-41 | 1319 | 2.0 | 0.75 | 0.21 |
| Framework | 120315 | | | | |
| MCM-41 | | | | | |
| Silica | | | | | |
| Hexagonal | MSU-H | 625 | 7.2 | 0.82 | 8.7 |
| Framework | H111101 | | | | |
| MSU-H | | | | | |
| Silica | | | | | |
| Carbon | Carbon | 567 | 7.0 | 0.70 | — |
| Coated | Coated | | | | |
| Hexagonal | MSU-H | | | | |
| MSU-H | H121204 | | | | |
| Framework | | | | | |
| Silica | | | | | |
| Hexagonal | SBA-15 | 507 | 17.2 | 1.0 | 9.0 |
| SBA-15 | 120320 | | | | |
| Framework | | | | | |
| Silica | | | | | |
| Wormhole | HMS-Htx | 941 | 2.4 | 1.40 | 5.0 |
| Framework | 100712 | | | | |
| Silica | | | | | |
| Wormhole | HMS-Htx | 996 | 2.4 | 1.20 | 11.5 |
| Framework | 120103 | | | | |
| Silica | | | | | |
| Lamellar | L 111006 | 291 | 8.8 | 0.95 | 0.14 |
| Framework | | | | | |
| Silica | | | | | |
| Commercial | HiSil 900G | 171 | 80 | 1.20 | 6.60 |
| Precipitated | 120104 | | | | |
| Silica | | | | | |
| γ-Alumina | γ-alumina | 396 | 2.0 | 0.24 | — |
| (2 nm pore) | 050301 | | | | |
| γ-Alumina | γ-alumina | 267 | 10 | 0.72 | — |
| (10 nm pore) | 050211 | | | | |
| η-Alumina | η-Alumina | 366 | 2.0 | 0.28 | — |
| | 120314 | | | | |
| η-Alumina | η-Alumina | 358 | 1.8 | 0.27 | 0.12 |
| | 120809 | | | | |
| Layered | SAP-90 | 675 | 2.0 | 1.1 | — |
| Alumino- | 090420 | | | | |
| silicate | | | | | |
| Saponite | | | | | |
| Zirconia | ZrO₂ | 208 | 4 | 0.23 | — |
| | 121106 | | | | |

With the exception of commercial precipitated HiSil 900G silica sample (PPG Silica Products) and the layered aluminosilicate (Saponite 090314), which are intrinsically mesoporous, all of the metal oxide compositions in Table 1 were prepared in the presence of surfactant micelles as porogens. Differences in the textural properties of surfactant-templated derivatives with equivalent framework structures (such as, for example, hexagonal framework structures) arise due to differences in synthesis conditions, such as the choice of surfactant micelles as a porogen, reagent concentration, reaction temperature, and reaction time. Included in Table 1 are the textural properties of two surface modified versions of mesoporous silica. These include a carbon-coated derivative of hexagonal mesoporous MCM-41 silica and an organofunctional form of mesocellular foam silica wherein 10% of the SiO₄ centers in the framework are replaced by RSiO₃ centers. In the examples of the present invention, the R group is a phenyl group, but, in general, R may be selected from a very broad family of organogroup compositions that form a stable covalent bond to silicon. Carbon-coated MCM-41 silica was prepared by pyrolysis of the quaternary ammonium ion porogen in the as-made MCM-41 reaction product. A phenyl—functionalized (“phenylated”) version of mesocellular foam silica was prepared by incorporating C₆H₅Si(OC₂H₅)₃ as a reagent in the assembly of the mesophase and then removing the block copolymer surfactant from the framework pores by solvent (ethanol) extraction. It is known in the art that organic surface modification of metal oxides can be accomplished through reaction of the oxide with silane coupling agents of the type RₙSi(OR′)₄₋ₙ, where n=1, 2, or 3, R is the desired organogroup and OR′ is a hydrolysable group.

The BET surface areas of the additives described in Table 1 exhibit Brunauer-Emmett-Taylor (BET) surface areas in the range 135-1319 m²/g and total pore volumes between 0.2 and 3.00 cm³/g. The Barrett-Joyner-Halenda (BJH) pore size distributions, as determined from nitrogen adsorption isotherms, span the super-microporous range 1.0-2.0 nm, the mesoporous range 2.0-50 nm, and the small macropore range 50-100 nm. That is, the pore size distribution represented by the additives in Table 1 span the range 1.0 to 100 nm. However, the majority of the total pore volume arises from pores in the mesopore range 2.0-50 nm. For this reason, all of the additives in Table 1 are “mesoporous”, even though the average pore size may be below 2.0 nm (c.f., η-malumina120809) or above 50 nm (c.f., precipitated HiSil 900G silica).

Table 2 provides literature references for the synthesis procedures used to prepare the mesoporous additives in Table 1, each of which is incorporated by reference herein in its entirety. Notably, the pore walls of the mesoporous silica additives are atomically disordered (amorphous), whereas the zirconia, alumina and aluminosilicate particles are crystalline on an atomic scale, as judged by the presence of Bragg reflections in the wide angle region of the x-ray powder diffraction patterns of these latter oxides.

TABLE 2
Literature References for the Procedures Used to Prepare Mesoporous Metal Oxides

| Mesoporous | |
|---|---|
| Metal Oxide | Literature Reference |
| Mesocellular | “Hexagonal to Mesocellular Foam Phase Transition in Polymer- |
| Foam Silica | Templated Mesoporous Silicas” John S. Lettow, Yong Jin Han, |
| | Patrick Schmidt-Winkel, Peidong Yang, Dongyuan Zhao, Galen D. Stucky, |
| | and Jackie Y. Ying, Langmuir 2000, 16, 8291-8295 |
| Organo- | “A veratile pathway for the direct assembly of organofunctional |
| functional | mesoporous mesostructures from sodium silicate” Janisha Shah, Seong-Su |
| Mesocellular | kim, Thomas J. Pinnavaia, Chemical Communications, 2004, (5), 572-573. |
| Foam Silica, | |
| 10% phenyl | |
| silylation | |
| Hexagonal | “Structural Order in MCM-41 controlled by Shifting Silicate |
| MCM-41 | Polymerization Equilibrium” Ryong Ryoo and Ji Man Kim, |
| Silica | J. Chem. Soc., Chem. Commun., 1995, 711 |
| Hexagonal | “Non-ionic surfactant assembly of ordered, very large pore |
| MSU-H | molecular sieve silicas from water soluble silicates” Seong-Su |
| Silica | Kim, Thomas R. Pauly and Thomas J. Pinnavaia, |
| | J. Chem. Soc., Chem. Commun., 2000, 1661 |
| Carbon | “Nanocasting of carbon nanotubes: in-situ graphitization of a |
| Coated | low-cost mesostructured silica templated by non-ionic surfactant micelles” |
| Hexagonal | Seong-Su Kim, Dong-Keun Lee, Jainisha Shah and Thomas J. Pinnavaia, |
| MSU-H | J. Chem. Soc., Chem. Commun., 2003, 1436 |
| Silica | |
| Hexagonal | “Nonionic Triblock and Star Diblock Copolymer and Oligomeric |
| SBA-15 | Surfactant Syntheses of Highly Ordered, Hydrothermally Stable, Mesoporous |
| Silica | Silica Structures” Dongyuan Zhao, Qisheng Huo, Jianglin Feng, Bradley |
| | F. Chmelka, and Galen D. Stucky, J. Am. Chem. Soc. |
| | 1998, 120, 6024-6036 |
| Wormhole | “Tailoring the Framework and Textural Mesopores of HMS Molecular |
| Framework | Sieves through an Electrically Neutral (S° I°) Assembly Pathway” |
| Silica | Wenzhong Zhang, Thomas R. Pauly, and Thomas J. Pinnavaia, |
| | Chem. Mater. 1997, 9, 2491-2498 |
| Lamellar | “Lamellar silica mesostructures assembled from a new class of |
| Framework | Gemini surfactants: alkyloxypropyl-1,3-diaminopropanes” In Park, |
| Silica | Seong-Su Kim, and Thomas J. Pinnavaia, Journal of Porous Materials |
| | 2010, 17, 133-138 |
| Commercial | http://www.ppg.com/specialty/silicas/productsegments/Documents/ |
| Precipitated | HiSil233Dand233GDBrochure.pdf |
| HiSil 900G | |
| Silica | |
| γ-Alumina | “Mesostructured Forms of γ-Al₂O₃” Zhaorong Zhang, |
| | Randall W. Hicks, Thomas R. Pauly, and Thomas J. Pinnavaia, |
| | J. Am. Chem. Soc. 2002, 124, 12294-12301 |
| η-Alumina | “Mesostructured Forms of the Transition Phases η- and _{χ}-Al₂O₃” |
| | Zhaorong Zhang and Thomas J. Pinnavaia, |
| | Angew. Chem. Int. Ed. 2008, 47, 7501-7504 |
| Layered | “Synthesis and properties of nanoparticle forms saponite clay, |
| Alumino- | cancrinite zeolite and phase mixtures thereof” Hua Shao, Thomas J. Pinnavaia, |
| silicate | Microporous and Mesoporous Materials, 2010, 133 10-17 |
| Zirconia | “Effect of process parameters on the synthesis of mesoporous |
| | nanocrystalline zirconia with triblock copolymer as template” M. Rezaei, |
| | S. M. Alavi, S. Sahebdelfar and Zi-Feng Yan, J Porous Mater |
| | 2008 15, 171-179 |

Each particle-loaded composite UF membrane was prepared as described in Examples 1-7 for the neat membranes, except the desired amount of mesoporous metal oxide was first added to the solvent and the mixture was sonified in a bath sonifier (60 Hz, 40 watts) or, more preferably, a horn sonifier (400 watt Branson Model 102C) to achieve particle dispersion.

Table 3 provides the properties of composite PSF membranes prepared from mesoporous oxides in comparison to the neat membrane prepared by the method of Example 1. All of the silica mesophases provide at least a 50% increase in pure water flux at loadings of 2.5 to 5.0 phr with little or no penalty in rejection efficiency toward Dextran molecules with a molecular weight of 12 kDa. Without being limited or bound by theory, the retention of rejection fidelity indicates that the increase in flux arises due to an increase in the number UF pores in the membrane skin or to an improvement in the wetability of the filtration pores, or both.

TABLE 3
UF Properties of Neat and Composite PSF UF Membranes
Prepared with PEG-400 as Porogen According to
the Methods of Examples 1 and 7.

| Mesoporous | | | | Dextran | |
|---|---|---|---|---|---|
| Oxide | Additive | Loading | Flux | Rejection | |
| Additive | ID | (phr) | (L/m²HrB) | (%) | |
| none | none | 0.0 | 0.74 ± 0.34 | 29.0 | [12 kDa] |
| Hexagonal | SBA-15 | 5.0 | 5.1 ± 1.6 | 51.4 | [12 kDa] |
| SBA-15 Silica | 120320 | 10 | 6.29 | — | |
| Mesocellular | FE110701 | 2.5 | 1.11 | 14.2 | [12 kDa] |
| Foam Silica | | 5 | 18.9 | 33.9 | [12 kDa] |
| | | 10 | 14.9 | — | |
| Mesocellular | F100602 6 | 5.0 | 4.62 | — | |
| Foam Silica | | | | | |
| Mesocellular | F120711 | 5.0 | 3.75 | 6.8 | [12 kDa] |
| Foam Silica | | | | 52.8 | [25 kDa] |
| | | | | 91.4 | [80 kDa] |
| Commercial | HiSil 900G | 2.5 | 1.34± 0.36 | — | |
| Precipitated | | 5.0 | 1.25 ± 0.31 | 23.0 | [12 kDa] |
| Silica | | | | | |
| Hexagonal | MSU-H | 5.0 | 2.74 ± 0.53 | 27.1 | [12 kDa] |
| Framework | H111101 | | | | |
| Silica | | | | | |
| Wormhole | HMS-Htx | 5.0 | 7.00 | — | |
| Framework | 100712 | | | | |
| Silica | | | | | |
| Hexagonal | MCM-41 | 5.0 | 2.57 ± 0.72 | 13.4 | [12 kDa] |
| MCM-41 | 120315 | | | | |
| Silica | | | | | |
| Carbon | Carbon- | 5.0 | 7.79 | — | |
| Coated | Coated | | | | |
| MSU-H | MSU-H | | | | |
| Silica | H121204 | | | | |
| γ-Alumina | γ-Alumina | 5.0 | 2.05 ± 0.82 | 13.1 | [12 kDa] |
| (10 nm | 050211 | | | | |
| pores) | | | | | |
| γ-Alumina | γ-Alumina | 5.0 | 6.6 | 11 | [12 kDa] |
| (2 nm | 050301 | | | | |
| pores) | | | | | |
| η-Alumina | η-Alumina | 2.5 | 11.3 | — | |
| | 120314 | 10.0 | 25.5 | 26.6 | [12 kDa] |
| Layered | Saponite | 5.0 | 1.04 | 19.5 | [12 kDa] |

| | | | | |
|---|---|---|---|---|
| Alumino- | 090420 | | | — |
| silicate | | | | |
| Zirconia | ZrO₂ | 1.0 | 8.34 | — |
| | 121106 - | 5.0 | 25.5 | |

Notes:
In this Table 3 and elsewhere, the loading is express as parts of mesoporous oxide per 100 parts of polymer (phr) and flux values are normalized to one atmosphere (bar) pressure. The Dextran molecular weights are provided in brackets. Values with standard deviations were obtained by averaging three or more independent specimens. All other values are for single measurements or, occasionally, two independent measurements.

The best-performing silica mesophase among those presented in Table 3 is Mesocellular Foam Silica FE110701 which provides a 25-fold increase in pure water flux in comparison to the neat polymer. Coating the pores of the silica with carbon provides an improvement in flux as indicated by a comparison of flux values for MSU-H silica and carbon coated MSU-H silica.

The crystalline alumina and zirconia mesophases provide superior flux values in comparison to their atomically amorphous silica counterparts. η-Alumina and zirconia provide 35-fold increases in flux at loadings of 10.0 and 5.0 phr, respectively. On the other hand, the crystalline layered aluminosilicate Saponite provided the smallest improvement in flux (only a 40% increase at 5.0 wt % loading) in comparison to the neat PSF membrane. Notably, the eta form of transition alumina provides substantially higher flux values in comparison to the gamma phase, indicating the importance of surface structure and polarity in determining the flow rate of water through the filtration pores in the skin of the polymer. Although in general the flux is greater for larger pore particles than smaller pore particles of the same composition, other factors also contribute to the permeability of the membrane composites. For example, mesocellular foam silica (110701) and HiSil 900G silica both have very large average pore sizes of 52.8 and 80 nm (c.f., Table 1), but the flux for a PSF composite membrane containing 5.0 phr of the former additive is 15-fold larger than the flux for a membrane made from an equivalent amount of the latter additive. Thus, the surface composition, surface structure and polarity, mesoporosity, as well as the fundamental particle size of the metal oxide additive all appear to play a role in determining the pure water flux and rejection properties of a composite membrane.

However, mesoporosity does appear to play a dominate role in limiting the shedding of the oxide additive under flux conditions. For instance, X-ray dispersive spectroscopy indicates that the Si/S ratio in the skin of a PSF composite containing 5.0 phr of mesocellular foam silica 110701 is unchanged before and after the determination of pure water flux. Particles lacking mesoporosity readily undergo shedding under analogous conditions. Without being limited or bound by theory, the ability of the polymer strands to penetrate the mesopores of the particle and thereby bind the particle to the pore walls may account for particle retention of flow conditions.

Table 4 provides the properties of low permeability composite PSF membranes prepared from mesoporous oxides in the absence of a porogen in comparison to the neat membrane prepared by the method of Example 2. Under these conditions, PSF forms relatively few UF pores, as evidence by the low flux value 0.19 L/m² HrB. However, the flux is increased by one to two orders of magnitude for composite membranes containing mesoporous silica and alumina particles. Moreover, the rejection values toward 12 KDa Dextran of 26% to 53% compare favorably with the 29% value for a neat PSF membrane made in the presence of PEG-400 (c.f., Table 3). Without being limited or bound by theory, these results indicate the particles are capable of nucleating UF pores in the membrane skin.

TABLE 4
UF Properties of Neat and Composite PSF Membranes
Prepared in the Absence of Porogen According
to the Methods of Examples 2 and 7.

| | | | | 12 kDa |
|---|---|---|---|---|
| | | | | Dextran |
| Mesoporous | Additive | Loading | Flux | Rejection |
| Oxide Additive | ID | (phr) | (L/m²HrB) | (%) |
| none | none | 0 | 0.19 | — |
| Mesocellular | MSP 1 | 5.0 | 2.5 | 26.0 |
| Foam Silica | FE110701 | 10.0 | 19.0 | 33.9 |
| Wormhole | HMS-Htx | 5.0 | 1.3 | 42.2 |
| Framework | 100712 | | | |
| Silica | | | | |
| η-Alumina | η-Alumina | 5.0 | 4.3 | 53.3 |
| | 120314 | 10.0 | 8.5 | — |

Table 5 provides the properties of high permeability composite PSF membranes prepared from mesoporous oxides in the absence of a porogen in comparison to the neat membrane prepared by the method of Example 3. Composites containing 1.0 to 10 phr of large and small pore mesoporous silica additives (wormhole framework silica and mesocellular foam silica) provide 1.6- to 2.3-fold increases in flux compared to the neat membrane made under phase inversion conditions, without compromising the rejection properties of the membrane toward 12 kDa Dextran or 66 kDa BSA. Without being limited or bound by theory, these results further confirm the pore forming properties of the mesophases.

TABLE 5
UF Properties of PSF Membranes Prepared in the Absence of
Porogen According to the Methods of Examples 3 and 7.

| | | | | 12 kDa | |
|---|---|---|---|---|---|
| Mesoporous | | | | Dextran | BSA |
| Oxide | Additive | Loading | Flux | Rejection | Rejection |
| Additive | ID | (phr) | (L/m²HrB) | (%) | (%) |
| none | none | 0.0 | 26.3 | 22.0 | 93.9 |
| Wormhole | HMS-Htx | 5.0 | 60.0 | — | 98.5 |
| Framework | 100712 | | | | |
| Silica | | | | | |
| Mesocellular | FE110701 | 1.0 | 46.4 | — | 99.9 |
| Foam Silica | | 10.0 | 42.0 | 27.0 | — |

Table 6 provides the UF properties of composite PES membranes containing 5.0 phr of mesoporous silica and alumina particles in comparison to the neat membrane prepared by the method of Example 4. The small mesopore wormhole silica and large mesopore mesocellular foam silica both boost the pure water flux in comparison to the neat membrane by at least 1.4-fold at a loading of 5.0 phr without compromising the rejection properties toward 12 kDa Dextran.

TABLE 6
UF Properties of PES Membranes Prepared with PEG-400 as
Porogen According to the Methods of Examples 4 and 7.

| | | | | 12 kDa |
|---|---|---|---|---|
| Mesoporous | | | | Dextran |
| Metal Oxide | Additive | Loading | Flux | Rejection |
| Additive | ID | (phr) | (L/m²HrB) | (%) |
| none | none | 0 | 4.2 | 28.7 |
| Mesocellular | FE110701 | 5.0 | 8.84 | 45.5 |
| Foam Silica | | | | |
| Wormhole | HMS-Htx | 5.0 | 6.0 | — |
| Framework Silica | 100712 | | | |
| η-Alumina | η-Alumina | 5.0 | 16.8 | 22.1 |
| | 120314 | | | |

Table 7 provides the UF properties of composite PES membranes containing 1.0 phr of four different versions of mesoporous silica in comparison to the highly permeable neat membrane prepared by the method of Example 5. Even at this relatively low mesophase loading, the pure water flux of this highly permeable membrane is improved by as much as 24% in comparison to the neat polymer membrane.

TABLE 7
UF Properties of PES Membranes Prepared with PVP as
Porogen According to the Methods of Examples 5 and 7.

| | | | | BSA |
|---|---|---|---|---|
| Mesoporous | Additive | Loading | Flux | Rejection |
| Metal Oxide | ID | (Phr) | (L/m²HrB) | (%) |
| none | none | 0 | 415 | 95.7 |
| Mesocellular | FE 110701 | 1.0 | 422 | 96.8 |
| Foam Silica | | | | |
| Wormhole | HMS-Htx | 1.0 | 502 | 95.1 |
| Framework | 120103 | | | |
| Silica | | | | |
| Lamellar | L 111006 | 1.0 | 513 | — |
| Framework | | | | |
| Silica | | | | |
| Organo- | 10% Ph- | 1.0 | 433 | — |
| functional | F120724EE | | | |
| Mesoporous | | | | |
| Foam Silica | | | | |

Table 8 provides the UF properties of composite PVDF membranes containing 5.0 phr of representative silica and alumina mesophases in comparison to the neat membrane prepared by the method of Example 6. The presence of the mesophases improves the pure water flux by as much as 80% while also improving filtration effectiveness.

TABLE 8
Properties of Neat and Composite PVDF Membranes Prepared
According to the Methods of Examples 6 and 7.

| | | | | 12 kDa |
|---|---|---|---|---|
| Mesoporous | Additive | Loading | Flux | Dextran |
| Metal Oxide | ID | (phr) | (L/m²HrB) | Rejection (%) |
| none | none | 0 | 3.30 | 35 |
| Mesocellular | FE120711 | 5.0 | 5.80 | 67.5 |
| Foam Silica | | | | |
| Wormhole Silica | HMS-Htx | 5.0 | 6.00 | — |
| | 100712 | | | |
| η-Alumina | 120314 | 5.0 | 3.50 | 72.3 |

### Example 8

Example 8 illustrates the pure water flux and rejection properties of PSF and PVDF composite membranes made by melt compounding the mesoporous additive and the polymer prior to dispersing the mixture in the casting solution solvent. This compounding procedure is an alternative to the use of ultrasound or high sheer mixing as a means of breaking down the particle aggregates into fundamental particles. The methods used to cast the composite membranes were the same as those described for the neat membranes in Examples 1 and 6, except that mesoporous metal oxide particles were included in the formulation as additives to the polymer prior to its being dissolved in the solvent.

Table 9 compares the pure water flux and rejection efficiencies of PSF and PVDF composite UF membranes made through the use of compounding and sonication methods to achieve mesoporous particle dispersion. Included in Table 9 are the properties of the neat polymers. Both dispersion methods afford composite membranes with pure water flux values substantially larger than the neat membranes. However, the compounding method is preferred, as it generally provides higher pure water flux values with little or no compromise in rejection properties.

TABLE 9
UF Properties of Composite Membranes Made through the Use of Sonication and
Compounding Methods to Achieve Mesoporous Particle Dispersion in the Membrane Matrix.

| | | | | | | | 12 kDa | |
|---|---|---|---|---|---|---|---|---|
| | Mesoporous | | Particle | | | Flux | Dextran | BSA |
| | Oxide | | Dispersion | Casting | Loading | (L/m²Hr | Rejection | Rejection |
| Polymer | Additive | Additive ID | Method | Method | (phr) | B) | (%) | (%) |
| PSF | none | none | none | Example 1 | 0.0 | 0.74 | 29 | — |
| PSF | Mesocellular | MSP-1 | Sonication | Example 1 | 5.0 | 2.87 | 32 | 98.6 |
| | Foam Silica | FE110701 | | | | | | |
| PSF | Mesocellular | MSP-1 | Compounding | Example 1 | 5.0 | 60 | 19 | 99.3 |
| | Foam Silica | FE110701 | | | | | | |
| PSF | Mesocellular | F120711 | Sonication | Example 1 | 5.0 | 11 | 15 | 98.7 |
| | Foam Silica | | | | | | | |
| PSF | Mesocellular | F120711 | Compounding | Example 1 | 5.0 | 14 | — | 99.2 |
| | Foam Silica | | | | | | | |
| PSF | Wormhole | HMS-Htx | Sonication | Example 1 | 5.0 | 20 | NA | 98.2 |
| | Silica | 100712 | | | | | | |
| PSF | Wormhole | HMS-Htx | Compounding | Example 1 | 5.0 | 53 | 12 | 99.0 |
| | Silica | 100712 | | | | | | |
| PVDF | none | none | none | Example 6 | 0.0 | 3.30 | 35.0 | — |
| PVDF | Mesocellular | MSP-1 | Sonication | Example 6 | 5.0 | 10.0 | 45.0 | — |
| | Foam Silica | FE110701 | | | | | | |
| PVDF | Mesocellular | MSP-1 | Compounding | Example 6 | 5.0 | 53.5 | 41.0 | — |
| | Foam Silica | FE110701 | | | | | | |
| PVDF | Wormhole | HMS-Htx | Sonication | Example 6 | 5.0 | 6.0 | — | — |
| | Silica | 100712 | | | | | | |
| PVDF | Wormhole | HMS-Htx | Compounding | Example 6 | 5.0 | 11.0 | — | — |
| | Silica | 100712 | | | 15.0 | 14.4 | | |

### Example 9

Example 9 illustrates the mechanical properties of polysulfone composite membranes containing 5.0 phr loadings of representative mesoporous silica additives.

Tensile measurements were performed on a UTS Analyzer according to ASTM 882 “Standard Test Method for Tensile Properties of Thin Plastic Sheeting”. Membranes strips were cut by following procedure B (Dual Blade Shear Cutter) of ASTM D 6287-09 method “Standard Practice for Cutting Film and Sheeting Test Specimens”. The strips were 10.5 inches long and 1 inch wide. The membranes were soaked in water and tested in the wet state. The grip separation was 5 inches with a 2 inch tape separation. The load cell was 20 pounds and the cross head speed was 0.5 inch/minute.

Table 10 reports the tensile modulus, tensile strength, and elongation at break values for wet membrane composites containing 5 phr surfactant-templated silica mesophases with mesocellular foam and hexagonal framework structures. Included in Table 10 are the mechanical properties of the neat membrane, as well as a composite made from commercial mesoporous precipitated silica, which is not surfactant templated. Within the reported standard deviations of the measurements, the tensile properties of the composite membranes specimens are equivalent to those of the neat membrane. Thus, the benefits of improved flux and rejection provided by these metal oxide additives are not compromised by penalties in mechanical properties.

TABLE 10
Mechanical Properties of Polysulfone Composite
Membranes Containing 5.0 phr Loadings of Representative
Mesoporous Silica Additives

| | Mesoporous Metal Oxide Additive | | | |
|---|---|---|---|---|
| | | | Commercial | Hexagonal |
| | | Mesocellular | Precipitated | Framework |
| Mechanical | | Foam Silica | Silica | Silica |
| Property | none | FE 110701 | HiSil 900G | H111101 |
| Tensile | 161 ± 14 | 169 ± 18 | 182 ± 27 | 165 ± 35 |
| Modulus (MPa) | | | | |
| Tensile | 4.94 ± 0.20 | 4.86 ± 0.18 | 4.63 ± .53 | 4.97 ± 0.10 |
| Strength (MPa) | | | | |
| % Elongation | 22.7 ± 4.7 | 23.0 ± 2.9 | 14.3 ± 5.9 | 27.5 ± 6.5 |
| at Break | | | | |

While certain representative embodiments and details have been shown for purposes of illustrating the invention, it was apparent to those skilled in the art that various changes may be made without departing from the scope of the disclosure, which is further described in the following appended claims.

We claim:

1. A composite membrane composition comprising mesoporous particles at a loading effective to increase the pure water flux in comparison to a neat membrane composition comprising a membrane composition without the mesoporous particles, wherein the composite membrane composition and the neat membrane composition are prepared under analogous conditions.

2. The composite membrane composition of claim 1, wherein the mesoporous particles are mesoporous metal oxide particles.

3. The composite membrane composition of claim 2, wherein the mesoporous metal oxide particles are made from a metal component selected from the group consisting of silicon, aluminum, transition metals, post-transition metals, metalloid elements, lanthanide elements, actinide elements, alkali metal, and alkaline earth elements, and combinations thereof.

4. The composite membrane composition of claim 1, wherein the mesoporous particles are selected from the group consisting of mesoporous silicate particles, mesoporous metal oxide particles, mesoporous carbon particles, mesoporous metal particles, mesoporous non-oxidic ceramic particles, mesoporous metal calcogenide particles, mesoporous polymer particles, mesoporous organosilica particles, periodic mesoporous organosilica particles, mesoporous metal phosphate particles, and combinations thereof.

5. The composite membrane composition of claim 1, wherein the mesoporous particles are selected from the group consisting of silica, alumina, zirconia, aluminosilicate, titania, niobia, molybdenum oxide and combinations thereof.

6. The compositions of claim 5 wherein the mesoporous aluminosilicate is selected from the group comprising a clay and a zeolite.

7. The composition of claim 5, wherein alumina is selected from the group consisting of amorphous alumina, gamma-alumina, eta-alumina, gibbsite, boehmite, and mixtures thereof.

8. The composition of claim 5 wherein titania is selected from the group consisting of amorphous titanium dioxide, rutile, anatase, and mixtures thereof.

9. The composite membrane composition of claim 1, wherein the mesoporous particles are non-oxide mesoporous particles.

10. The composite membrane composition of claim 1 wherein the mesoporous particles are prepared in the presence of surfactant micelles as porogens.

11. The composite membrane composition of claim 1 wherein each of the mesoporous particles has a surface, wherein the surfaces of the mesoporous particles are modified by a coating of carbon.

12. The composite membrane composition of claim 2 wherein each of the mesoporous metal oxide particles has a surface, wherein the surfaces of the mesoporous metal oxide particles are modified by a coating of carbon.

13. The composite membrane composition of claim 1 wherein each of the mesoporous particles has a surface, wherein the surfaces of the mesoporous particles are modified by an organofunctional group.

14. The composite membrane composition of claim 2 wherein each of the mesoporous metal oxide particles has a surface, wherein the surfaces of the mesoporous metal oxide particles are modified by an organofunctional group.

15. The composition of claim 1 wherein the composite membrane is made by a process selected from the group consisting of a liquid phase inversion processes, a phase inversion during compounding process, and an interfacial polycondensation reaction process.

16. The composite membrane composition of claim 1 wherein the composite membrane composition is made by dispersing mesoporous particles in a solvent phase of a phase inversion casting solution using high shear mixing.

17. The composite membrane composition of claim 1 wherein the composite membrane composition is made by dispersing mesoporous particles in a phase inversion solvent of a casting solution using high intensity ultrasound sonication.

18. The composite membrane composition of claim 1 wherein the composite membrane composition is made by dispersing the mesoporous particles in a thermoplastic polymer matrix under melt compounding conditions prior to dissolving the thermoplastic polymer matrix in a phase inversion casting solvent.

19. A phase inversion method of making a composite membrane comprising the steps of:
providing an amount of mesoporous particles;
dispersing the mesoporous particles in a solvent phase of a casting solution using high shear mixing;
forming a composite membrane composition with the casting solution having mesoporous particles dispersed therein, wherein the amount of mesoporous particles in the composite membrane is sufficient to increase the pure water flux of the composite membrane in comparison to a neat membrane without the mesoporous particles, wherein the composite membrane and the neat membrane are prepared under analogous phase inversion processes.

20. The method of claim 19 wherein the mesoporous particles are mesoporous oxide particles.

21. The method of claim 19 wherein the mesoporous particles are made from an element selected from the group comprising of carbon, silicon, aluminum, transition metals, post-transition metals, metalloid elements, lanthanide elements, actinide elements, alkali metal elements, alkaline earth elements, and combinations thereof.

22. The method of claim 19, wherein the mesoporous particles are selected from the group consisting of mesoporous silicate particles, mesoporous metal oxide particles, mesoporous carbon particles, mesoporous metal particles, mesoporous non-oxidic ceramic particles, mesoporous metal calcogenide particles, mesoporous polymer particles, mesoporous organosilica particles, periodic mesoporous organosilica particles, mesoporous metal phosphate particles, and combinations thereof.

23. The method of claim 19 wherein the mesoporous particles are mesoporous oxide particles selected from the group consisting of silica, alumina, zirconia, aluminosilicate, titania, niobia, molybdenum oxide and combinations thereof.

24. The method of claim 19, wherein the high shear mixing is done using ultrasound.

25. The method of claim 19, further comprising the step of:
dispersing the mesoporous particles in a thermoplastic polymer matrix prior to dispersing in the solvent phase of the casting solution.
